(19) United States
(12) Patent Application Publication
(10) Pub. No.: US 2016/0338366 A1
(43) Pub. Date: Nov. 24, 2016

(54) USING WOLFFIA GENUS PLANT MATERIAL FOR PREPARING DOUGH

(71) Applicant: HINOMAN LTD, Or Yehuda (IL)

(72) Inventors: Ehud ELITUV, MOSHAV DEKEL (IL); Mircea Dan BUCEVSCHI, REHOVOT (IL)

(73) Assignee: HINOMAN LTD, Or Yehuda (IL)

(21) Appl. No.: 15/112,692

(22) PCT Filed: Jan. 27, 2015
(86) PCT No.: PCT/IL2015/050098

§ 371 Date: Jul. 20, 2016

Related U.S. Application Data
(60) Provisional application No. 61/931,835, filed on Jan. 27, 2014.

(51) Int. Cl. A21D 13/04; A23L 7/109; A21D 10/00; A21D 2/36

(52) U.S. Cl. CPC A21D 13/04; A21D 2/36; A23L 7/111; A21D 10/002; A23V 2002/00

(57) ABSTRACT

The present invention discloses a malleable mass of dough comprising: (a) dry material; said dry material comprises flour; and, (b) a liquid component; said liquid component comprising liquid essentially originating from fresh whole Wolffia genus plant added to said dry material during the kneading process; said liquid component extractable from said fresh whole plant during the plant disruptive dough kneading process. The present invention further discloses methods for preparing the aforementioned malleable mass of dough.

### TECHNOLOGICAL FIELD OF THE INVENTION

The present disclosure is in the field of food industry and in particular to preparation dough and specifically pasta dough and wet pasta dough with improved nutritional and sensory facts.

### BACKGROUND OF THE INVENTION

World Human Food represents a complex problem that is under pressure from several factors of different origin: social, economic, political and cultural. Numerous international organizations, regional, state and local government are involved in providing solutions to resolve main objectives: a) population health and b) necessary of food.

International Organization for food-FAO in several reports [Food Outlook. Global Market Analysis, 2012] shows that lack of food at the global scale is on a negative trend, having as the main causes, demographic growth, interest increased for biofuel and unfavorable socio-economic situations. These reports have been drawn up taking into consideration traditional food resources available, with particular reference to cereals: wheat, rye, oats and rice. From the proposed solutions for compensating the traditional food deficit, it is also the use of unconventional resources, including marine aquatic plants (algae and microalgae) and freshwater (duckweeds), the latter owning the largest economic potential [Leng R. A. 1999]. The main arguments in favor of this proposal are: high protein content (greater than 30% dry mater) and remarkable productivity (greater than 40 tones/hectare/year) with the difference that the production can be provided continuously, in opposition to the seasonality of plant culture.

Population health is directly correlated with the quality of available food. Eliminating from discussion the cultural factor associate to food consumer food, the daily diet must thus be developed in order to ensure the normal physiology of the human body (the nutritional facts), and on the other hand to stimulate the appetite for food consumption (the sensory facts).

Nutritional facts are the daily requirement of food chemical components that need to be ingested in order to ensure the normal physiology of the human body. The values for the nutritional facts are governed by legislation at the level of each country. For example it can be seen the recommendations made by US-RDI [Dietary Reference Intakes: The Essential Guide to Nutrient Requirements, 1997-2006].

Health Daily Intake can be found in the form of daily menu (consisting of three meals: breakfast, lunch and dinner), that includes various food products (animal and vegetable) as raw materials and ingredients. In most cases the menu's components are chosen so that to be ensured an energy of 2000 kcal/day for a 70 kg body weight [Food energy, FAO, 2003].

To ensure the healthy daily menu is recommended to select the components in relation to the following factors:
a) chemical composition of the raw materials from which is prepared the menu's components, and
b) chemical compositions of ingredients used,
c) processing technology with the lowest negative effect on the nutritional quality of raw materials and ingredients.

The main components of daily menu are: a) bakery and pasta products (as bread); b) milk; c) cheese; d) meat; e) vegetables and f) fruits.

Satisfying the clients' requests on the taste and curative effects of bread and pasta, is done by using the ingredients added to the base composition and adjustment of technological parameter used on composition's processing. The most commonly used ingredients are: sugar, fat, milk and milk products and/or emulsifiers.

A special category of ingredients is referred to:
materials with high content of proteins, polysaccharides (gluten, soy flour, etc.);
materials rich in minerals, antioxidants and vitamins: vegetables and plant extracts: (onion, garlic, spinach, etc.)

The formulations that use non-traditional ingredients lead to the types of bakery and pasta products which are addressed to a market niche that may refer to:

a) normal (healthy) consumers but with certain dietary preferences;
b) consumers with health problems (cardiac, diabetic, obese, deficiency of metabolism, etc.)

One way to improve, or to change the properties of foodstuffs containing flour dough, is to change the characteristics/properties of the traditional dough. In general, vegetables are known to contain health-beneficial ingredients, such as various vitamins, minerals, fibers and other minor ingredients which contribute to our well being, such as carotenes, phytosterols, antioxidants, etc and, therefore, there is a growing awareness to their importance

Vegetable-enriched dough will be beneficial for people, so they will consume more vegetables, because of their health beneficial ingredients. The vegetable-enriched dough would allow people to consume pizzas, burekas, etc. which they previously could not, or did not want to eat for health reasons.

Use of vegetables as non-traditional ingredients for special bakery and pasta products is done taking into account the following aspects:
the quantity of vegetal material added to the basic composition shall be adjusted so that specific chemical components found in the end products quantity consumed per day, to frame in the range accepted by RDI (important restrictions are for various categories of minerals as Fe, Mn and others);
the use of vegetable ingredients, it does so, to not appear significant changes in the traditional processing operations: preparation of dough (time and rheological properties); dough raising (fermentation time, spongy volume etc.), baking (time, temperature);
sensory facts of bread (smell, taste, color, texture, shelf-live, etc.)

Of the many variants of bakery and pasta products, known in art, further are discussed only those who use unconventional ingredients like vegetable products from the following categories: vegetables, fruits and other, in fresh state or have suffered some degree of processing (drying, dehydration, squeezing, jelly and others).

Rosilda C. Savale in U.S. Pat. No. 2,264,721 relates to foodstuffs and the method of making the same, and more particularly to a bread or like product containing spinach in a palatable form by reason of its being associated with wheat or other flours also containing high nutritive value, and other ingredients serving to modify or disguise the natural savor of the spinach In a manner to make the foodstuff pleasing to the taste and thus overcome the prejudices against same. In order to produce bread, biscuits and the like articles of foodstuff having the desired properties and quality, it is necessary to mix with the dough, before baking the bread, raw or uncooked green spinach cut or ground into small particles, and to use the juice or liquor of the spinach in supplying moisture to the dough. By so doing, all of the constituents of the spinach found in the leaves and in the stems are utilized during baking, and any of the constituents which would be lost when boiling or stewing or otherwise cooking spinach, are retained in the product, either being absorbed by the flour or precipitated in the mass of the loaf. When the spinach is baked, it will retain much of its native moisture, native and since it is dispersed throughout the dough, it will aid materially in preventing the drying out of the bread. It has been used the following formulation: 4 level cups of flour; 1 cup of finely divided and crushed spinach and the sap or liquor there from: 2 level tablespoons of granulated sugar, 1 level tablespoon of salt; 1 tablespoon of butter, lard or other fatty matter as a substitute therefore and ½ of the cake of yeast. These materials are compounded in the following manner: green spinach, after being washed and drained, is cut up or finely divided and crushed by a passing it through an ordinary meat chopper or other cutting device, preferably using a plate having flue holes. The liquor or juice from the spinach has added thereto a small quantity of water or milk, ordinary table salt, sugar and fat in about the proportions stated. The mixture is then brought to the boiling point and allowed to cool for a short time, say substantially ten minutes. While still warm, the ground spinach is added and the mixture allowed to stand until it is tepid. Salt is used in sufficient quantity to draw juice or liquor from the raw or green spinach in excess of that expressed during cutting and crushing. The yeast cake is then dissolved in warm water in the usual manner and added to the above mixture. Flour is then added to the mixture until a spongy dough is formed. The dough may be kneaded or otherwise worked to ensure the dispersion of the particles of spinach throughout the batch, and then placed in a warm spot and allowed to raise in a manner common in the making of bread. After raising, the dough is again kneaded and additional flour added, and again allowed to raise while in the final form of the product in the bake pan, for proofing.

Blase T. Messina in U.S. Pat. No. 3,352,688 relates to fillings used by the baking industry in their baked goods and more particularly to a water based gel, prepared by adding to water or to a water-fruit juice or water fruit puree mixture from about 0.25 to about 0.75% of sodium alginate based on the weight of the finished gel, together with a salt whose cations form a water-insoluble salt with alginic acid in combination with guar gum, locust bean gum, or starch. Most of the finished gel product is composed of the aqueous base, including the water, fruit juices, fruit puree and added sweetener. Thus, the percentages expressed above are essentially the same, whether expressed as a percent of the finished gel product or as a percent of the aqueous base in the use of this invention, the various ingredients.

Niclos M. Siunott in U.S. Pat. No. 3,537,863, relates to a method of making garlic bread in which the garlic flavor is preserved during baking. It is disclosed that a critical step in the preservation of the garlic flavor is to add the garlic at about the time of kneading after all other ingredients have been mixed together and just prior to baking Another critical factor is that the garlic should be added in a dry form. The disclosed theory of this action is that the flavor of the dry, dehydrated garlic is activated by the moisture or steam created during the baking process so that the development of flavor is complete at the same time that the baking is completed. The bread is disclosed as coming from the oven with full, fresh garlic flavor which is evenly distributed through-out the entire loaf. The term garlic “chips” is defined as including dehydrated, dry garlic flakes and dehydrated, dry minced garlic, but does not include garlic powder or the like. The preferred amount of garlic chips to be added is two tablespoons (or a cup) which equates to about of the volume of starter.

Richard L. Singer in U.S. Pat. No. 3,574,634, presents a low-calorie foodstuffs, namely doughs containing less than about 10 or 15 percent by weight of assimilable carbohydrate and consisting essentially of vital gluten, a non-nutritive edible filler, a vegetable gum, and water; dry mixes from which said doughs can be prepared by the addition of liquid; cooked and uncooked pasta products and leavened and unleavened baked goods, such as bread, breakfast cereals, and the like, prepared from said doughs. More particularly a dough convertible by heating into a calorie-poor foodstuff, said dough containing less than about 15 percent by weight assimilable carbohydrate and consisting essentially of about 15 to about 25 parts by weight of gluten flour containing vital gluten and having a protein:starch ratio of at least 2:1, about 35 to about 25 parts by weight of flour other than said gluten flour, about 40 to about 50 parts by weight of a non-nutritive edible cellulosic filler comprises cellulosic crystallite aggregates, about 1 to 10 parts by weight of a vegetable gum, together with sufficient water to form a dough.

Kritchevsky et al in U.S. Pat. No. 4,028,469 relates to foodstuffs, as bread containing substantial quantities of alfalfa provides a convenient, palatable form of introducing significant quantities of alfalfa into the human diet. The bread, which preferably contains honey, retains bread-like texture, taste and odor despite the presence of substantial quantities of alfalfa. Alfalfa, a nonnutritive fiber, functions as a hypocholesteremic agent. More particularly relates to a composition for preparing bread comprising a farinaceous dough containing a leavening agent and alfalfa, said alfalfa being present in an amount of from about 3.5 to 10% by weight. The bread product is made by baking a dough in the conventional manner. The dough is then shaped into a loaf. In practice it has been found that baking times of about 40 minutes at about 425.degree. F. provides a suitable product. The resulting bread has good taste and texture.

Jerome B. Thompson in U.S. Pat. No. 4,109,018 relates about a dough composition for making a bread product, said dough composition comprising wheat flour, water, salt, yeast, fermentable sugar, said dough composition containing from about 3 to about 9 parts by weight of an added vital wheat gluten, from about 5 to about 12 parts by weight of a protein material selected from the group consisting of low fat soy flour, nonfat dry milk, dried yeast flour, cottonseed flour, and mixtures thereof, from about 10 to about 20 parts by weight of an alpha cellulose flour, and from about 0.5 to about 6 parts by weight of a hydrophilic gum selected from the group consisting of synthetic cellulose ethers, gum guar and gum tragacanth and mixtures thereof, all of said ingredients being expressed as parts by weight per 100 parts of wheat flour. The baking process was a typical sponge-dough process using a 70% sponge. The sponge ingredients were mixed for three minutes at low speed on a Hobart Mixer. Sponges came out at 80.degree. F. and were allowed to ferment for 3.5 hours at this temperature. The dough ingredients and water to give a proper consistency were remixed with the sponge for three minutes in low speed and six minutes in second on the Hobart. The doughs, well developed by this mixing, were given a floor time of 20 minutes, were divided, given 10 minutes of overhead proof, sheeted and molded and panned. Dough pieces of 454 grams were used in pans, with a depth, width, and length of 21/2 inches.times. 33/4 inches.times. 91/8 inches. Pan proofing at 110.degree. F. was to ¾ inch above the pan. The loaves were baked at 435.degree. F. for 20 minutes. After one hour the loaves were sealed in polyethylene bags and stored for 12 hours at 70.degree. F. The loaves were then weighed and volumes determined by rape seed displacement. They were subjectively scored taking into account such factors as color, grain texture, symmetry, volume and flavor. The scoring is subjective and relative but by this system 83-87 is normal for commercial market bread.

Morton Satin in U.S. Pat. No. 4,237,170 relates about a composition for use in making a high fiber content white bread comprising 100 parts by weight flour and about 5 to 20 parts by weight field pea hull fibers having particle sizes in the range which pass a 20 mesh screen but do not pass an 80 mesh screen, said pea hulls being selected from the group consisting of yellow and green pea hulls and mixtures thereof. The pea fibers useful in the invention are obtained from the hulls of yellow or green field peas. Breads were baked using the above four blends and the control sample. A sponge and dough method was used. The doughs were mixed to maximum consistency, divided in 500 grams, rounded and given a 20 minute intermediate proof. They were then moulded and deposited into 16 oz. pans. The doughs were proofed to ¾″ above the pan and then baked for 25 minutes at 425.degree. F. The doughs showed a tendency to be somewhat sticky and slack and required an additional 10 to 15 minutes to proof.

Vanderveer et al. in U.S. Pat. No. 4,444,799, U.S. Pat. No. 4,62,485 relates to a composition or formulation and a process by which a relatively neutral-flavor gel ingredient is produced and incorporated in a base dough for the preparation of soft, edible, baked products, especially soft cookies in varieties such as chocolate chip, peanut butter, molasses, etc., the soft, edible, baked products having a surprisingly long and extended shelf-life. More particularly, the preferred raw materials, utilized to prepare the neutral-flavor gel, in proportions and in a manner described in greater detail hereinafter, comprise a high-fructose corn syrup, glycerine, an alginate gum, calcium sulfate dihydrate, and propylene glycol. The firm gel composition is very easily prepared by first blending the edible gum with the humectants, dispersing agent for the gum to a thick, syrup-like, lump-free consistency. The resulting blend is then mixed into the edible viscous syrup and mixed for sufficient time to provide a uniform blend. The edible calcium salt and the edible humectants, dispersing agent for the calcium salt are blended to form pourable, lump-free slurry and the resulting slurry is mixed into the blend viscous liquid gum and gum dispersing agent and mixing is continued until a uniform dispersion is obtained. The resulting mixture is then poured into containers which are then sealed and mixture is allowed to set. After it has set the containers can be stacked and stored or shipped. At some later point the firm gel can be used in the preparation of a cookie or cake dough or batter. A typical dough for making soft cookies, snacks and cakes can contain flour, sugar and/or a syrup sweetener such as invert syrup or high fructose syrup, shortening, baking powder and water. The amounts of these ingredients can vary over a very wide range depending upon the end product desired and the particular processing steps to be utilized. Based on 100 pounds of flour, the firm gel component of this invention can be incorporated in amounts of about 2 to about 100 pounds. The firm gel can contain substantial amounts of water, e.g., 19-20% or more. Considering all sources including separately added water, the moisture content of the dough composition can range from 20 to 60% and sufficient water should be present to provide the desired consistency to the dough to enable proper working and shaping of the dough. The dough is cut or otherwise shaped into the form and size of cookie or snack desired in a conventional manner and then is baked by convention procedures. Baking temperatures of about 325.degree. F. to about 450.degree. F. can be used. The higher temperatures will require less time for baking a given form of dough.

Roy W. Porter in U.S. Pat. No. 4,643,900 relates about a method for producing bakery and pasta products wherein is provided a dough conditioner composition of allium material is incorporated into dough formulations including flour, water and leavening agents. The allium material is used in effective amounts to function in reducing the mix-time required to develop dough, increasing the absorption of water by the flour during dough development, and increasing the extensibility of the dough. The preferred allium material used in the preparation of the dough improving composition is garlic, more preferably in a dehydrated form and in combination with an inert organic material. The developed dough is processed using conventional techniques and procedures including baking into a standard bakery and pasta product such as bread, crackers, pizza and sweet goods. The invention involves the use of a natural food material as an active agent. More particularly, it involves the incorporation of allium material, preferably dehydrated garlic, as a dough conditioner into standard dough formulations in amounts effective in functioning to reduce the mix-time required to develop dough. In addition dehydrated garlic increases absorption of water by the flour during dough development, and improves the extensibility of the dough. Upon subsequent processing and baking, the resultant product exhibits organoleptic characteristics generally expected of such products. For this invention preferably results with a flour-base dough product comprising an additive made from allium material in an amount effective to function as a dough improver preferably without contributing a noticeably perceptible flavor to the product. The dehydrated garlic when used in an amount in the range of up to about 0.5% by weight of flour, and preferably up to about 0.3% by weight flour is an effective amount to achieve the aforementioned results, it is more preferred to include dehydrated garlic in the range of about 0.01 to 0.3% by weight of flour. The most preferred range of dehydrated garlic which is functional in reducing the mix-time to fully develop dough is 0.01 to 0.05% by weight of flour whereas 0.05 to 0.25% by weight of flour is most preferred for improving the extensibility of the dough. The fully developed dough is then permitted a rest period prior to being subjected to conventional steps employed in the baking industry for forming dough into products such as bread loaves, rolls, buns or other unit configurations by dividing, rounding, benching, molding and panning the dough. Baking of dough for bread is typically conducted for about 16 minutes at a temperature of about 450.degree. F. for a one pound loaf of bread. During baking, the dough expands to the desired loaf volume.

K. M. Slimak in U.S. Pat. No. 5,234,706, U.S. Pat. No. 5,244,689 relates about a variety of different food products, prepared from edible roots, seeds, and starchy fruits including potatoes, arrowroot, water chestnut, jicama, buckwheat, legumes, millet, milo, barley, oats, corn, teff, rice, cotton seed meal, bread fruit, pumpkin, winter squash, white squash, plantain, banana, and jack fruit are substitutes for wheat and other grains, milk, eggs, and a partial substitute for nuts. A variety of starches, soluble fibers, and insoluble fibers may be combined to provide products that are substitutes for wheat and other grains, milk, eggs, and a partial substitute for nuts.

Lai et al. in U.S. Pat. No. 5,384,136 relate to a dough product that is enriched with a psyllium composition. The psyllium may range from about 1.0 to about 5.0 grams per one ounce. The dough product can include an amount of gluten to increase its volume. Also provided is a method for making the dough products. These dough products are useful in lowering serum cholesterol levels as well as for increasing dietary fiber in the diet of the individual consuming them.

Josef L. et al. in EP 1,715,748 A2 relates to vegetable-based dough that comprises softened gluten and added vegetable material. The vegetables comprise legumes and/or fruits and/or fibers and their derivatives. The term vegetable is meant to comprise fresh, canned, preserved, refrigerated, frozen, pickles, dehydrated, partially rehydrated, vegetables as well as vegetable juices, concentrates, purees and pastes. The vegetable dough essentially consists of softened gluten in admixture with vegetable materials or of an essentially homogeneous mixture of softened gluten, to which vegetable material has been added. The vegetable dough comprising 20-80% of vegetable ingredients, is produced by first softening a gluten mass, and then by mixing the resulting softened gluten with a preferred vegetable, until an essentially homogeneous mass is obtained. The vegetable-based dough, which, despite being based primarily on vegetable material as a main ingredient, has physical characteristics, such as elongation, break elongation, tensile strength, volume expansion, adhesion, die cutting characteristics, fibrous structure and molded form retention, that are very similar to those of a flour dough.

Komuves G. et al in EP 1,871,168 A1 relates to a bakery and pasta product with vegetables characterized by that it contains 0.5-40% by weight of vegetable flakes in addition to the usual bakery and pasta ingredients. According to a preferred embodiment of the invention the bakery and pasta product contains one or more vegetable flakes in an amount at least 0.5% by weight selected from the following group: 0.5-40% by weight carrot flakes, 0.5-30% by weight parsley root flakes, 0.5-30% by weight parsnip root flakes, 0.5-30% by weight tuber of celery flakes, 0.5-20% by weight pepper flakes, 0.5-15% by weight leek flakes, 0.5-15% by weight spring onion flakes, 0.01-10% by weight parsley leaf flakes, 0.01-10% by weight celery leaf flakes and 0.01-5% by weight garlic flakes. The invention also provides a half-manufactured product, so-called premix for the manufacturing of the above mentioned products, which premix contains 2-85% by weight of vegetable flakes in addition to the usual bakery and pasta ingredients. The dough is baked in a bakery and pasta oven saturated with steam for 40-45 minutes (the temperature of the casting is 220° C., then after 5 minutes is 700′C).

Ree S. et al. in WO 2004/023880 discloses a kind of bread utilizing the nutritional value of vegetables which bread contains compulsorily powdered vegetables, concentrated liquid vegetables, powdered grains and dried, diced vegetables. Vegetable sources are: a) alfalfa; b) asparagus; c) cauliflower; d) brussel sprouts; e) broccoli; f) bell peppers; g) lettuce; h) kale; i) onions; j) summer squash; k) cucumbers; l) shiitake mushrooms; m) turnips; n) fennel; o) peas; p) scallions; q) red beets; r) carrots; s) tomatoes; t) spinach; u) radishes; v) sea tangles w) celery. The method for making a yeast bread utilizing vegetables for their nutritional value, comprising the steps of: a) sifting together in a large bowl all purpose flour, powdered grains, sugar, commercial yeast, salt, and powdered vegetables so as to form a first composition; b) mixing together in another large bowl concentrated liquid vegetables, soy bean milk, and shortening so as to form a second composition; c) heating the second composition to 120 degrees F. so as to form a heated composition; d) adding the heated composition gradually to the first composition so as to form a third composition; e) beating the third composition for 2 minutes at medium speed, scrapping the large bowl occasionally so as to form a first beaten composition; f) adding to the first beaten composition egg and all purpose flour so as to form a fourth composition; g) beating the fourth composition for 2 minutes at high speed, scrapping the large bowl occasionally so as to form a second beaten composition; h) stirring dehydrated diced vegetables into the second beaten composition so as to form a stirred composition; i) greasing a 1 lb. loaf pan; j) adding the stirred composition into the 1 lb. loaf pan; k) covering the 1 lb. loaf pan with plastic wrap; 1) letting the stirred composition rise in a warm draft free area until double in bulk; m) pre-hating an oven to 325 degrees F.; and n) baking for about 25 minutes.

Andersson E. et al. in WO 2009/037086 relates to a dough comprising flour, eggs and/or water, characterized in that the dough further comprises one or more fresh vegetables mixed and kneaded to the other ingredients, wherein the amount of fresh vegetables in the dough is up to 50%, preferably up to 40% and more preferably it is comprised between 20-36 by weigh of the dough. The fresh vegetable is taken in the group consisting of spinach, carrots, peas, tomatoes, zucchini. The amount of flour is up to 60 by weigh of the dough. The flour is a cereal flour, preferably taken from the group consisting of durum, semolina, rice flour, alone or in combination with each other. The amount of water added when preparing the dough, is comprised between 0-20% by weigh of the dough. That the dough also comprises starch, gluten, alginate, gums. The preparation of a fresh pasta, comprising the following steps: —mixing and kneading flour with eggs and/or water realizing a dough; —sheeting the dough; —forming the sheet of dough in order to obtain fresh pasta having the desired shape, characterized in that the dough in realized by mixing and kneading, in addition to the other ingredients, also fresh vegetables, and in that the amount of fresh vegetables in the dough is up to 50%, preferably up to 40% and more preferably it is comprised between 20-36 by weigh of the dough.

Dimitrov V. I. et al. in US Pat. Appl. 20060141100 relates a bread product, characterized in that in the volume of the bread product is formed sections comprising different vegetables or fruits containing coloring pigments and said vegetables or fruits are in the form of powders, purees and/or natural colorants added to the dough, whereby each section has taste and color determined by the vegetable or fruit added to the dough and the taste and colour of each section is different from the taste and colour of the adjacent sections. The vegetables with coloring effect are: spinach, carrots, tomatoes, red peppers, green peppers, nettles, dock, seaweeds, broccoli, brussels sprouts, cauliflower, string beans, onion leafs, garlic leafs, peas, lettuce, beet, pumpkin and mushrooms, as well as spices with coloring effect such as parsley, curcuma, soy sauce, celery, mint and basil. The fruits with coloring effect are: cherries, morello cherries, strawberries, raspberries, figs, apples, blueberries, blackberries, cornel-cherries, olives, citrus fruits such as oranges, bananas, kiwi, pineapple and grapefruit. The vegetables or fruits are powders of particle size from 20 to 120 μm. The content of the vegetable or fruit added to the dough of a given section is between 0.1 and 100% by weight of the flour used in this particular section. The doughs are kneaded again and left for about 40 minutes to slacken. After the simultaneous preparation of the doughs they are put together mechanically, without mixing, and twisted, then they are cut, molded, baked and packed.

Barbier, A. et al. in EP 1,893,026 A1 discloses a process of making bread with vegetables or fruit, for the areas of bakery and pasta, pastry and food, especially fast food, characterized in that in the composition of the dough to be cooked, is replaced at least 30 percent of the flour produced by a plant consisting of crushed or grated vegetables, or the flesh of certain fruits, flour mixture and plant product is kneaded with water after incorporation of salt, so as to give a baker's dough. That the plant product consists of a fresh or dehydrated vegetable consisting zucchini, eggplant, tomato, or a mixture of these vegetables. The proportion of vegetables is between 35 and 45 percent.

Gere I. et al. in EP 1,871,168 A1 relate to a bakery and pasta product with vegetables according to claim 1 characterized in that it contains one or more vegetable flakes altogether at least in an amount of 0.5% by weight selected from the following group: 0.5-40% by weight carrot flakes, 0.5-30% by weight parsley root flakes, 0.5-30% by weight parsnip root flakes, 0.5-30% by weight tuber of celery flakes, 0.5-20% by weight pepper flakes, 0.5-15% by weight leek flakes, 0.5-15% by weight spring onion flakes, 0.01-10% by weight parsley leaf flakes, 0.01-10% by weight celery leaf flakes and 0.01-5% by weight garlic flakes.

Kipping F. et al. in EP1,250,844 A2 relates to a bread dough, cake, and the like as well as a base for other dough extrudates, selected on the basis of flour, water and salt, with at least two ingredients from one or more of the following groups: Fabaceae, Gramineae, Chenopodiaceae, Amranthaceae, Euphorbiaceae, Polygonaceae, Panizeen, wherein said essential amino acids of the ingredients are complementary such that all of quotient of a required value for the essential amino acid in the organism, and the essential amino acid content in the dough, the smallest ratio is greater than the smallest ratio for each individual ingredient.

Dimitrov, Visarion Ivanov et al in WO 2005/000028 discloses bread product containing components with vegetable origin in one or more layers which components are added to the dough in the forms of powder and/or juice and/or puree and/or natural colorant. The vegetable components are dried in a manner known per se and are powdered to determined size as 20-120 μm, or they are added to the dough in the form of juice (e.g. tomato) or pulp (e.g. carrot).

Liu Yufeng in China Patent 1,370,453 relates to the field of food production. The steamed bread with spirulina and milk is produced with refined flour, spirulina powder, milk powder, butter, fresh milk, protein sugar, sugar, yeast and water and through traditional process. It has complete and rich nutrients and unique taste and can provide people with rice nutrients.

Zvenyhorodskyy E. in CA 2715607 A1 relates to a bread additive comprising a composition of dried powder of macro-algae—Palmaria, Ascophyllum, Porphyra, Chondrus, Ulva, Alaria, Undaria, Laminaria and micro-algae—Chlorella, Spirulina, Dunaliella, Haematococcus that are introduced into flour prior to dough preparation; wherein percentage of said algae in said flour varies as follows: Palmaria—0.02-1.0%; Ascophyllum—0.02-1.0%; Porphyra—0.02-1.0%; Chondrus—0.02-5%; Chlorella—0.01-0.25%; Spirulina—0.01-0.25%; Dunaliella—0.01-0.25%; Haematococcus—0.01-0.25%; Ulva—0.02-1.0%; Alaria—0.02-1.0%; Undaria—0.02-1.0%; Laminaria—0.02-1.0%. The bread additive is introduced in said bread product in the form of micro-capsules incorporated said dry powder surrounded by a thin coagulated film made of liquefied Laminaria or Chondrus. The bread additive introduced into the bread after baking process, wherein surface of the bread is sprinkled after baking with mixture of the with viscous liquid made of Laminaria; and said viscous liquid fixes said powder on the bread surface by means of coagulated film; wherein said Laminaria is liquefied with sodium citrate, so transforming it into a viscous liquid.

LIU QUANQUAN in CN No. 1297687. The nutritious black bread has the basic composition of bread flour 25-30 wt %, bean powder 4-5 wt %. Sesame paste 2-3 wt %, rice flour 8-12 wt %. vegetable or fruit paste 5-10 wt %, glutelin powder 3-4 wt %, egg 8-12 wt %, yeast 0.3-0.5 wt %, sugar 3-5 wt %, rice vinegar 2-2.5 wt % and salt 0.8-1 wt % other than water. The bread of the present invention is savoury, light and crisp and rich in nutrients.

Darwin K. A. in DE 3700953 A1. The invention relates to a high-fiber soft bakery and pasta product in which the raw dough contains 1 to 70%, preferably about 45%, fruit and/or vegetables in fresh, boiled or frozen or otherwise preserved form, 5 to 95%, preferably 45%, bread-making cereal component in milled, coarsely ground and/or bruised form, 0.1 to 20%, preferably about 3%, of a liquid-binding material, preferably of vegetable origin, in total 1 to 50%, preferably 7%, raising agent, liquid and salt and materials contained therein for flavoring, preferably of vegetable origin, for acidification, for sweetening, if necessary, for preservation and/or other known dough additives. This high-fiber soft bakery and pasta product is produced in that the amount of the fruit and/or vegetable necessary for a batch is comminuted in a suitable manner to piece sizes of 0 to 20 mm, then, in a suitable container with stirring, in a ratio according to the invention, cereal component, water—if desired with an added amount according to the invention of vegetable juice—raising agent, salt and other dough additives known per se and a moisture binding-material corresponding to the invention in an amount and type according to the invention are added and processed to form a dough, which is then baked to completion in portions or as a whole.

Bakery and pasta products, cited above, shows no rheological parameters that define the characteristics of processing doughs obtained by formulations which has been claimed or presented as examples, which doesn't allow to appreciate their technological feasibility.

Also, the above cited, are not referred to food contribution, exemplified at the daily intake as various values for serving mass, compared to products that do not contain non-traditional ingredients as vegetables.

In addition, the use of Wolffia in several foods comprising a dough is presented in figures. For example, Wolffia muffins, Wolffia tomato sandwich, and Wolffia apple pie a-la-mode. However, the wolffia is presented only in the dough of the muffin. No details are given regarding the way Wolffia was used—in what form, quantities and process. Armstrong W: “Wayne Armstrong's treatment of Lemnaceaea.” 18 Jul. 2012, Retreived from the internet: URL https;//web.archive.org/web/20120718230402; http://waynesword.palomar.edu/genimg2.htm.

In addition, the use of Wolffia is discussed in general homesteading forum. The forum discusses the uses of duckweed. One of the suggested uses is to combine them with food like bread, biscuits or muffins. It is mentioned that the addition of duckweed will increase protein content of the food item but it does not explain the amounts and for of duckweed to be used.

In addition, patent document WO2005/000028 recites a bread product enriched with a product of vegetable origin added to the dough in the form of powder and/or juices and/or purees and/or natural colorants. The taste and color of the bread is determined by the product of vegetable origin added. The document does recite specifically duckweed and relates generally to vegetables. In addition, the document does not recite the farinographic profile of the dough.

In addition, patent document EP2036442 recites a pasta dough comprising water, eggs and flour. In addition, it also comprises fresh vegetables in order to give the pasta the color and some taste and flavor of vegetables. This patent application only discloses changes in taste and/or color of the dough but not its farinographic profile. The document does recite specifically duckweed and relates generally to vegetables. In addition, the document does not recite the farinographic profile of the pasta or bread.

It is therefore still a long felt and unmet need to disclose dough with novel and improved characteristics for the production of baked and pasta products.

### SUMMARY OF INVENTION

In one aspect, the invention relates to a combination of components comprising a freshwater aquatic plant as plant component to the botanical Lemnaceae family also known as the duckweed family, for preparation dough used to obtaining foodstuff as yeast and non-yeast baked products and the preparation of pasta dough as well as wet pasta dough.

In a further embodiment, the Wolffia genus of duckweed's family, adopted as plant component of the invention, by cultivation in controlled conditions, is not harmful for human health, and by specific chemical composition allows the preparation of foodstuff with improved nutrition and sensory facts, comparative with baked product which comprising vegetables, known in art.

In a further embodiment, the plant component of the invention is used together with traditional flour in a ratio flour:plant as weight dry basis with values in the range from 98:2 by weight dry basis up to 42:58 by weight dry basis, preferably the ratio flour:plant as weight dry basis with values in the range from 97:3 by weight dry basis up to 55:45 by weight dry basis, and more preferable with values in the range from 95:5 by weight dry basis up to 65:35 by weight dry basis.

In a further embodiment, the combination of components comprising a freshwater aquatic plant as plant component, through additional content of protein and minerals such as calcium and iron re-found in baked end product, open a new niche in the commercial area of foodstuff, which has higher calorific value and simultaneously, improve the capacity of some metabolic deficiencies and/or therapeutic, without generating side-effects as: the tendency of growth of body weight, high blood pressure and the like, recorded in art for certain categories of products that contain plants.

In a further embodiment of the present invention is to produce bakery and pasta products that are advantageous from a physiological point of view and at the same time have excellent organoleptic properties, are appetizing and contain only natural materials. The purpose of the invention is not only to increase the range of tasty novelties (from commercial point of view), that do not contain artificial flavor-enhancing agents, different consistency-improving agents and preservatives.

In a further embodiment, the plant component of the invention, it is used as: whole fresh plant or integral fresh pulp juice or powder dry plant, offering the opportunity to obtain a wide variety of bakery and pasta products, without technological restrictions known in art for certain categories of products.

In a further embodiment, the plant component of the invention, as whole fresh plant or integral fresh pulp juice, due to water content which they have, are used as full water source, in dough formulation and preparation, without to be necessary the inclusion in the formulation of water as an independent component, which has economic benefits, translated by reducing the cost of manufacturing.

In a further embodiment, the combination of components comprising a freshwater aquatic plant as plant component does not require special equipment for processing.

In a further embodiment, the combination of components comprising a freshwater aquatic plant as plant component, it can process using all known processes in art, with no adjustment of parameters' values used in the preparation of different types of bakery and pasta products, especially wet pasta products and wet noodle products.

It is thus an object of the present invention to disclose a malleable mass of dough comprising: (a) dry material; the dry material comprises flour; and, (b) a liquid component; wherein the liquid component comprising liquid essentially originating from fresh whole Wolffia genus plant added to the dry material during the kneading process; the liquid component extractable from the fresh whole plant during the plant disruptive dough kneading process; post kneaded ratio of the whole fresh plant to disrupted plant is at least 50% lower than a corresponding dough comprising same ratio of dry material to liquid component defined as water, the corresponding dough is further characterized by: (a) Wolffia added post kneading, or (b) Wolffia added after characteristics of dough have been substantially attained, or (c) Wolffia added in addition to the liquid component of the dough, or any combination thereof.

It is a further object of the present invention to disclose the malleable mass of dough as defined above, wherein no more than 20% of the total amount of the liquid component, is externally added water.

It is a further object of the present invention to disclose the malleable mass of dough as defined in any of the above, wherein at least 80% of the liquid component comprises liquid originating from the fresh whole Wolffia.

It is a further object of the present invention to disclose the malleable mass of dough as defined in any of the above, The dough of any one of claims 1 to 3, wherein about 100% of the liquid component comprises liquid originating from the fresh whole Wolffia.

It is a further object of the present invention to disclose the malleable mass of dough as defined in any of the above, wherein the Wolffia plant is selected from the group consisting of Wolffia angusta, Wolffia arrhiza, Wolffia australiana, Wolffia borealis, Wolffia brasiliensis, Wolffia columbiana, Wolffia cylindracea, Wolffia elongata, Wolffia globosa, Wolffia microscopica, and Wolffia neglecta.

It is a further object of the present invention to disclose the malleable mass of dough as defined in any of the above, wherein the flour is selected from the group consisting of wheat flour, whole flour, buckwheat flour (gluten free), durum wheat, rice flour, rye flour, oat flour, corn flour, teff flour, and combinations thereof.

It is a further object of the present invention to disclose the malleable mass of dough as defined in any of the above, wherein the whole fresh plant is selected from the group consisting of whole plant, essentially intact plant, whole cells and any combination thereof.

It is a further object of the present invention to disclose the malleable mass of dough as defined in any of the above, wherein the disrupted plant is selected from the group consisting of pieces of the plant, plant part, cell debris, fractionated plant cells, shriveled fronds, a powder of the whole plant, juice plant, partially dried plant, essentially fully dried plant, processed plant and any combination thereof.

It is a further object of the present invention to disclose the malleable mass of dough as defined in any of the above, wherein the juice plant comprises suspension from the fresh plant cells with a solid content of between about 1% and about 15%.

It is a further object of the present invention to disclose the malleable mass of dough as defined in any of the above, wherein the dough has characteristic rheological properties relative to a corresponding dough having similar liquid to total dry material ratio, the corresponding dough being absent of the Wolffia plant.

It is a further object of the present invention to disclose the malleable mass of dough as defined in any of the above, wherein the dough has higher rigidity relative to a corresponding dough having similar liquid to total dry material ratio, the corresponding dough being absent of the Wolffia plant.

It is a further object of the present invention to disclose the malleable mass of dough as defined in any of the above, wherein the dough has higher stability to mechanical solicitations relative to a corresponding dough having similar liquid to total dry material ratio, the corresponding dough being absent of the Wolffia plant.

It is a further object of the present invention to disclose the malleable mass of dough as defined in any of the above, wherein the dough has higher τcritic value relative to a corresponding dough having similar liquid to total dry material ratio, the corresponding dough being absent of the Wolffia plant.

It is a further object of the present invention to disclose the malleable mass of dough as defined in any of the above, wherein the dough has a lower deformation capacity relative to a corresponding dough having similar liquid to total dry material ratio, the corresponding dough being absent of the Wolffia plant.

It is a further object of the present invention to disclose the malleable mass of dough as defined in any of the above, wherein the dough has higher plasticity relative to a corresponding dough having similar liquid to total dry material ratio, the corresponding dough being absent of the Wolffia plant.

It is a further object of the present invention to disclose the malleable mass of dough as defined in any of the above, wherein the dough has higher consistency relative to a corresponding dough having similar liquid to total dry material ratio, the corresponding dough being absent of the Wolffia plant.

It is a further object of the present invention to disclose the malleable mass of dough as defined in any of the above, having essentially homogenous coloring.

It is a further object of the present invention to disclose the malleable mass of dough as defined in any of the above, wherein the color of the mass of dough is optically significantly different from the color of a corresponding dough prepared with the same type and same amount of flour a similar liquid to total dry material ratio, the corresponding dough is further characterized by at least one property selected from the group consisting of: (a) being absent of the Wolffia plant, (b) Wolffia added post kneading, (c) Wolffia added after characteristics of dough have been substantially attained, (d) Wolffia added in addition to the liquid component of the dough, and any combination thereof.

It is a further object of the present invention to disclose the malleable mass of dough as defined in any of the above, wherein the dough has a color falling within or being near the plant color range; the plant color is selected from the group consisting of green pigment range, red pigment range and yellow pigment range.

It is a further object of the present invention to disclose the malleable mass of dough as defined in any of the above, wherein the plant has a plant color of green or near green.

It is a further object of the present invention to disclose the malleable mass of dough as defined in any of the above, wherein the dough comprises dry plant material, the dough having a ratio (w/w) of the flour to the dry plant material of between about 98:2 to 42:58.

It is a further object of the present invention to disclose the malleable mass of dough as defined in any of the above, wherein the flour to dry plant material ratio is between 97:3 to 55:45.

It is a further object of the present invention to disclose the malleable mass of dough as defined in any of the above, wherein the flour to dry plant material ratio is between 95:5 to 65:35.

It is a further object of the present invention to disclose the malleable mass of dough as defined in any of the above, wherein the dough comprises a liquid component and total dry material, the total dry material comprises flour and plant material when measured in dry form.

It is a further object of the present invention to disclose the malleable mass of dough as defined in any of the above, wherein the dough comprises a weight % ratio of liquid to total dry material of between 55% to 85%.

It is a further object of the present invention to disclose the malleable mass of dough as defined in any of the above, wherein the ratio of liquid to total dry material is between 60% to 80%.

It is a further object of the present invention to disclose the malleable mass of dough as defined in any of the above, wherein the ratio of liquid to total dry material is between 65% to 75%.

It is a further object of the present invention to disclose the malleable mass of dough as defined in any of the above, wherein the plant material has an average diameter of up to 12 mm.

It is a further object of the present invention to disclose the malleable mass of dough as defined in any of the above, wherein the plant material has an average diameter of between 0.02 mm and 12 mm.

It is a further object of the present invention to disclose the malleable mass of dough as defined in any of the above, wherein the plant material has an average diameter of between 0.03 mm and 2 mm.

It is a further object of the present invention to disclose the malleable mass of dough as defined in any of the above, wherein the plant material has an average diameter of between 0.5 mm and 1 mm.

It is a further object of the present invention to disclose the malleable mass of dough as defined in any of the above, wherein the plant material has an average diameter of 0.6 mm to 1 mm.

It is a further object of the present invention to disclose the malleable mass of dough as defined in any of the above, wherein the plant material has an average diameter of less than 1 mm.

It is a further object of the present invention to disclose the malleable mass of dough as defined in any of the above, wherein the dough mass comprises components of the liquid of the plant.

It is a further object of the present invention to disclose the malleable mass of dough as defined in any of the above, wherein the components are selected from the group consisting of: proteins, protein complexes, saccharides oligosaccharides, fats, vitamins, vitamin A, vitamin B1, vitamin B3 and any combination thereof.

It is a further object of the present invention to disclose the malleable mass of dough as defined in any of the above, wherein the dough mass comprises plant proteins absorbed by or associated with the flour.

It is a further object of the present invention to disclose the malleable mass of dough as defined in any of the above, wherein the dough has a characteristic farinographic profile with an intermediate peak before reaching its development time.

It is a further object of the present invention to disclose the malleable mass of dough as defined in any of the above, characterized by at least one property selected from the group consisting of: a higher development time (DT), a lower stability time (S), a higher degree of softening (DS), a higher consistency (C) value and any combination thereof, as compared to a corresponding dough having similar liquid to total dry material ratio, the corresponding dough being absent of the Wolffia plant.

It is a further object of the present invention to disclose the malleable mass of dough as defined in any of the above, being characterized by at least one farinographic parameter selected from the group consisting of development time (DT) of about 5 minutes, stability time (S) of about 2 minutes, degree of softening (DS) of about 80 to 115 FU and any combination thereof.

It is a further object of the present invention to disclose the malleable mass of dough as defined in any of the above, characterized by a farinograph profile having an intermediate peak time prior to reaching its development time.

It is a further object of the present invention to disclose the malleable mass of dough as defined in any of the above, characterized by rising at a predetermined time point to a level that is from about 8% to about 400% greater than the rise at the predetermined time point of a corresponding dough being absent of the plant material.

It is a further object of the present invention to disclose the malleable mass of dough as defined in any of the above, wherein the rising at the predetermined time point is to a level that is between 10% and 50% greater than the rising of a corresponding dough being absent of the plant material.

It is a further object of the present invention to disclose the malleable mass of dough as defined in any of the above, being in a cooled or frozen state.

It is a further object of the present invention to disclose the malleable mass of dough as defined in any of the above, wherein the dough has a consistency similar to a dough in which its liquid fraction comprises water.

It is a further object of the present invention to disclose the malleable mass of dough as defined in any of the above, wherein the dough has a consistency of +/−15% of a dough in which its liquid fraction comprises water.

It is a further object of the present invention to disclose the malleable mass of dough as defined in any of the above, wherein the dough has a consistency in the range of about 600 to about 630 FU.

It is a further object of the present invention to disclose the malleable mass of dough as defined in any of the above, wherein the dough additionally comprises salt.

It is a further object of the present invention to disclose the malleable mass of dough as defined in any of the above, wherein the dough is combined with at least one additional food ingredient.

It is a further object of the present invention to disclose the malleable mass of dough as defined in any of the above, wherein the at least one additional food ingredient is selected from the group consisting of flavoring agent, vegetable or vegetable part, oil, vitamins, olives and grains.

It is a further object of the present invention to disclose the malleable mass of dough as defined in any of the above, wherein the dough further comprises a leavening agent.

It is a further object of the present invention to disclose the malleable mass of dough as defined in any of the above, wherein the leavening agent is selected from the group consisting of: unpasteurized beer, buttermilk, ginger beer, kefir, sourdough starter, yeast, whey protein concentrate, yogurt, biological leaveners, chemical leaveners, baking soda, baking powder, baker's ammonia, potassium bicarbonate and any combination thereof.

It is a further object of the present invention to disclose the malleable mass of dough as defined in any of the above, wherein the plant contributes to the rising of the dough as compared to dough prepared without the plant material.

It is a further object of the present invention to disclose the malleable mass of dough as defined in any of the above, wherein the dough is used to prepare a yeast and non-yeast food product.

It is a further object of the present invention to disclose the malleable mass of dough as defined in any of the above, wherein the food product is in a form selected from the group consisting of partially or fully cooked, baked, stewed, boiled, broiled, fried and any combination of same.

It is a further object of the present invention to disclose the malleable mass of dough as defined in any of the above, wherein the dough is used to make pasta.

It is a further object of the present invention to disclose the malleable mass of dough as defined in any of the above, wherein the dough is used to make wet pasta.

It is a further object of the present invention to disclose the malleable mass of dough as defined in any of the above, wherein the dough has a lower τcritic value relative to a corresponding dough having similar liquid to total dry material ratio, the corresponding dough being absent of the Wolffia plant.

It is a further object of the present invention to disclose a food product comprising the dough as defined in any of the above.

It is a further object of the present invention to disclose the food product as defined in any of the above, wherein the dough is combined with at least one additional food ingredient.

It is a further object of the present invention to disclose the food product as defined in any of the above, being partially or fully cooked, baked, stewed, boiled, broiled, fried and combination of same.

It is a further object of the present invention to disclose the food product as defined in any of the above, selected from the group consisting of bakery, pasta, noodles, cereal and dough chips.

It is a further object of the present invention to disclose the food product as defined in any of the above, comprising an overall green or near green pigment texture, and comprising distributed therein Wolffia genus plant.

It is a further object of the present invention to disclose a method of preparing a malleable mass of dough comprising steps of: (a) obtaining dry material; the dry material comprises flour; and (b) obtaining a liquid component; the liquid component comprising liquid essentially originating from fresh whole Wolffia genus plant. It is within the scope that the method additionally comprising steps of kneading the dry material with the fresh whole Wolffia genus plant to disrupt at least part of the fresh whole plant thereby extracting the liquid component from the fresh whole plant, such that the post kneaded ratio of the whole fresh plant to disrupted plant is at least 50% lower than a corresponding dough comprising same ratio of dry material to liquid component defined as water, the corresponding dough is further characterized by: (i) Wolffia added post kneading, or (ii) Wolffia added after characteristics of dough have been substantially attained, or (iii) Wolffia added in addition to the liquid component of the dough, or any combination thereof.

It is a further object of the present invention to disclose the method as defined in any of the above, additionally comprising a step of kneading the dry material with the fresh whole Wolffia genus plant under conditions sufficient to cause disruption of at least part of the fresh whole plant thereby sufficient amount of liquid is extracted from the whole plant to form the dough.

It is a further object of the present invention to disclose the method as defined in any of the above, additionally comprising a step of selecting the conditions from the group consisting of kneading time, kneader torque moment, kneading velocity, dough temperature, tip speed and any combination thereof.

It is a further object of the present invention to disclose the method as defined in any of the above, additionally comprising a step of kneading at least flour and fresh plant for a time interval between the dough reaches its arrival time and the dough's departure time as determined by a farinograph profile of the dough.

It is a further object of the present invention to disclose the method as defined in any of the above, additionally comprising a step of kneading the flour and fresh plant with at least one additional food ingredient.

It is a further object of the present invention to disclose the method as defined in any of the above, additionally comprising a step of selecting the at least one additional food ingredient from the group consisting of leavening agent, flavoring agent, vegetable or vegetable part, oil, vitamins, salt, grains and any combination thereof.

It is a further object of the present invention to disclose the method as defined in any of the above, comprising cooling or freezing the dough.

It is a further object of the present invention to disclose the method as defined in any of the above, wherein at least 80% of the liquid component comprises liquid originating from the fresh whole Wolffia.

It is a further object of the present invention to disclose the method as defined in any of the above, wherein about 100% of the liquid component comprises liquid originating from the fresh whole Wolffia.

It is a further object of the present invention to disclose a method of preparing a food product comprising steps of providing a dough as defined in any of the above, and processing the dough, the processing is selected from the group consisting of combining the dough with a food ingredient, rising, kneading, extruding, molding, shaping, cooking, stewing, boiling, broiling, baking, frying and any combination of same.

### BRIEF DESCRIPTION OF THE FIGURES

FIG. 1 is a schematic illustration of core embodiments of the present invention;

FIG. 2 is a micrograph of dough of the present invention (FIG. 2A) as compared to exemplary prior art dough (FIG. 2B);

FIGS. 3A to 3D show characterization of dough without Wolffia plant (FIGS. 3A and 3B) and with Wolffia plant (FIGS. 3C and 3D), including the respective farinograph profiles (FIGS. 3A and 3C) and photographic images (FIGS. 3B and 3D);

FIGS. 4A to 4C are farinographic profiles of dough obtained without Wolffia plant (FIG. 4A) or with Wolffia plant (FIGS. 4B and 4C) according to another embodiment;

FIG. 5 is a photo showing the beginning of the step of uniting the ingredients for preparing wet pasta;

FIG. 6 is a photo showing the beginning of the kneading process in which the flour starts to unite with the plant;

FIGS. 7A and 7B are photos of the kneading process;

FIGS. 8A and 8B are photos of wet pasta made with duckweed;

FIG. 9 is a photo of bread made from dough containing about 80% fresh whole duckweed;

FIG. 10 is a solicitation program designed for rheological characterization of dough samples;

FIG. 11 is graphically illustrating the influence of oscillation frequency on the complex elastic modulus G* for samples S1A and S1B;

FIG. 12 is graphically illustrating solicitations of samples S1A and S1B with the element Oscillation Stress Sweep, as an embodiment of the present invention;

FIG. 13 is graphically illustrating variation in tan δ values between samples S1A and S1B upon solicitation with element Oscillation Frequency Sweep;

FIG. 14 is graphically illustrating the influence of solicitation's time on the compliance of S1A and S1B as dough;

FIG. 15 is graphically illustrating the influence of solicitation frequency on complex elastic modulus G* for samples S2A and S2B;

FIG. 16 is graphically illustrating the influence of solicitation frequency on rheological tan(δ) values of samples S2A and S2B;

FIG. 17 is graphically illustrating the influence of solicitation tension with element Oscillation Frequency Sweep for samples S3A and S3B;

FIG. 18 is graphically illustrating the influence of solicitation frequency on complex elastic modulus G* for samples S4A and S4B;

FIG. 19 is graphically illustrating the influence of solicitation frequency on rheological property tan(δ) for samples S4A and S4B;

FIG. 20 is graphically illustrating the influence of solicitation tension with element Oscillation Frequency Sweep for samples S4A and S4B;

FIG. 21 is graphically illustrating the influence of solicitation's frequency on rheological property tan(δ) of samples S5A and S5B;

FIG. 22 is graphically illustrating the influence of solicitation's time on complex viscosity η* with element Oscillation Time Sweep after 60 minutes from the preparation starting point of dough samples S1A and S1B;

FIG. 23 is graphically illustrating the influence of solicitation's frequency on complex elastic modulus G* for samples S6A and S6B;

FIG. 24 is graphically illustrating the behavior of samples S1A and S1B at solicitation with shear rate in the range of 0 to about 100 s⁻¹, when the Thixotropic Loop element is examined;

FIG. 25A is graphically illustrating creep analysis of pasta dough A (prepared with water) and pasta dough B (prepared with the Wolffia plant)

FIG. 25B is presenting pasta dough parameters; particularly creep analysis data of dough without plant material and dough prepared with plant material, having the same solid or total dry material to liquid component ratio;

FIG. 26A is graphically illustrating the influence of oscillation frequency on the complex elastic modulus G* for samples A and B. Rigidity evaluation of pasta dough samples A and B is shown in FIG. 26B;

FIG. 27 is graphically illustrating the influence of solicitation frequency on rheological property tan(δ) for samples A and B;

FIG. 28 is graphically illustrating the influence of solicitation tension evaluated by Oscillation Frequency Sweep for samples A and B;

FIG. 29A and FIG. 29B are presenting laboratory technical characteristics of the two types of flour exemplified in the present invention wheat flour (FIG. 29A) and rye flour (FIG. 29B); and

FIG. 30 is presenting characteristics of bakers fresh dough yeast formulation as an example of yeast used in the present invention.

### DETAILED DESCRIPTION OF THE PREFERRED EMBODIMENTS

The combination of the components of the invention represents a formulation for preparation of yeast and non-yeast baked products as well as pasta and wet pasta products with improved nutrition facts, based on dough with similar process ability of common dough, which comprises a freshwater aquatic plant as a liquid component.

The present invention provides a malleable mass of dough comprising: (a) dry material; said dry material comprises flour; and, (b) a liquid component; said liquid component comprising liquid essentially originating from fresh whole Wolffia genus plant added to said dry material during the kneading process; said liquid component extractable from said fresh whole plant during the plant disruptive dough kneading process; post kneaded ratio of said whole fresh plant to disrupted plant is at least 50% lower than a corresponding dough comprising same ratio of dry material to liquid component defined as water, said corresponding dough is further characterized by: (i) Wolffia added post kneading, or (ii) Wolffia added after characteristics of dough have been substantially attained, or (iii) Wolffia added in addition to the liquid component of said dough, or any combination thereof.

The plant used as a component of dough according to the present invention is an aquatic plant belonging to the family Lemnaceae, also known as the duckweed family (as it contains the duckweeds or water lentils).

Duckweed species are small floating aquatic plants found worldwide and often seen growing in thick, blanket-like mats on still, nutrient-rich fresh and brackish waters. They are monocotyledons belonging to the botanical family Lemnaceae and are classified as higher plants, or macrophytes, although they are often mistaken for algae [Skillicorn P. et al. 1993].

The most known genera species of duckweeds family [Hasan, M. R. ET AL, 2009] are:
LEMNA (L gibba; L. disperna; L gibba; L japonica; L minima; L minor; L minuscula; L paucicostata; L perpusilla; L polyrrhiza; L turionifera; L. trisulca; L valdiviana)
SPIRODELA (S. biperforata; S. intermedia; S. oligorrhiza; S. polyrrhiza; S. punctata)
WOLFFIA (W. arrhiza; W. australiana; W. Columbiana; W. microscopia; W. neglecta, Wolffia angusta, Wolffia borealis, Wolffia brasiliensis, Wolffia cylindracea, Wolffia elongata, Wolffia globosa and Wolffia microscopica)
WOLFFIELLA (W. caudate; W. denticulate; W. lingulata; W. oblonga; W. rotunda)

All species occasionally produce tiny, almost invisible flowers and seeds, but what triggers flowering is unknown. Many species of duckweed cope with low temperatures by forming a special starchy “survival” frond known as a turion. With cold weather, the turion forms and sinks to the bottom of the pond where it remains dormant until rising temperatures in the spring trigger resumption of normal growth. [Skillicorn P. et al. 1993].

The idea to use duckweed as source of food for humans and animals has been first lanced in 1978 by W. Hillman and D. Culley [Hillman W. S. et al 0.1978], taking in consideration the fact that this plants have a high content of proteins and a productivity superior versus other species of aquatic and/or terrestrial plants. Ulterior, being confirmed the initial idea, the research has been extended on duckweeds uses as source of food, because its amino acids balance and the high content of vitamins and minerals, confer to them a high nutritive value comparatively with the food soybean based.

Remarkable nutritional potential of duckweeds is mentioned in many publications [BHANTHUMNAVIN. K. ET AL. 1971; Stomp, A-M, 2005; Leng R. A 1999; Leng, R. A. et al. 1995; Iqbal S. 1999; Erdal Yilmaz et al. 2004; Huqu K. S. et al. 1996; Porath D. in U.S. Pat. No. 5,269,819; U.S. Pat. No. 6,013,525 or Dickey L. F. et al in U.S. Pat. No. 7,622,573]. The FAO Report [Leng R. A 1999] shows that duckweed, in general, has been used as a food by poor people in the past. The major benefit from such an addition to a diet is likely to have been as a supplement rich in phosphorous and/or vitamin A. However, undoubtedly there is a role for Lemna as a source of essential amino acids. Duckweed makes a fine addition to a salad and is quite tasty.

Where vegetable proteins are scarce in some regions of the world and particularly during a prolonged dry season or in normally and areas, there is considerable scope to improve the nutritional status of the mal-nourished child through the use of duckweed directly or after extraction of a protein from the plant. Many aquatic plants may be used for such purposes with some additional purification to remove any toxic.

As a source of essential amino acids, the proteins of water plants have comparable amino acid compositions to that of most leaf proteins. The protein extract would provide quite considerable benefits to communities constrained to vegetarian diets through their economic situation. This would particularly apply to those without a source of milk and where there is a long period of dependency on dried foodstuffs deficient in vitamin A or in phosphorous as occurs in many of the arid regions of the world. On the other hand with the increasing demand for vegetable proteins in the industrialized world duckweeds could make a fine addition to most mixed salads and could be regarded as a commercial crop, provided quality water was used to grow the plants.

The transposition in practice of the concept to substitute the classical source of protein as soybeans with duckweeds [Chareontesprasit N. et al. 2001; Chantiratikul A. et al 2010], has been and continue to be restricted by the fact that these aquatic plants have a remarkable capacity of bonding organic and inorganic substances [Leng R. A 1999]. High susceptibility of contamination of the duckweeds with toxic substances (natural and/or synthetic) is the principal cause that their nutritive performances has been treated as second level of importance.

Accordingly, the combination disclosed herein may comprise any such member of Lemnaceae family. Preferred are the plants of the genus Wolffia. The plant component Wolffia, that is the object of present invention, has characteristics that meet the requirements of chemical purity for a foodstuff, being grown in aquatic culture farm of Agro-industrial Company HINOMAN Ltd in Israel, in conditions of controlled growth (e.g. chemical composition of the nutrient media, lighting and protection from outside contamination), in the form of fresh green vegetable.

Wolffia Nutritional Facts of the vegetal biomass corresponds to the data from Table 1.

Accordingly, in the combination disclosed herein the plant component is used in the following variants: a) whole fresh plant; b) integral fresh pulp juice; c) powder dry plant, and any combination thereof, in correlation with the possibilities of using the plant for the preparation of yeast and non-yeast bakery and pasta products.

As used herein the term “about” denotes ±25% of the defined amount or measure or value.

The term “dough” should be understood as having its commonly used meaning, namely, a composition comprising as minimal essential ingredients flour and a source of liquid, for example at least water that is subjected to kneading and shaping. The dough is characterized by its malleability.

The term “malleable” should be understood as defining the capacity of the dough for adaptive changes without necessary being easily broken and as such its pliability, elasticity and/or flexibility which thereby allows the subjecting of the dough to any one of the following processing steps: stretching, shaping, extending, sheeting, morphing, fitting, kneading, molding, modeling, or the like. The shaping of the dough may be by any instrument having predetermined shapes or by a rolling pin or by hand.

In accordance with the context of the present disclosure, it should be understood that when referring to malleable dough, it is to be distinguished from a flour and liquid blend, such as those used for preparing muffins that is a fluid in nature and as such cannot be shaped without the use of a supporting mold. In other words, malleable dough is not a flowing or pourable blend.

As appreciated, flour has no malleable or elastic characteristic, however, upon mixing with a liquid such as water, hydration of wheat proteins occurs and dough is produced. Formation of dough may be considered as formation of a skeleton providing the structure and malleability of the dough. As such, the term “malleable mass” in the context of the present invention denotes a pliable thick mixture of flour and liquid with the flour being preferably hydrated with the liquid to form dough mass.

The term “whole fresh plant” is to be understood to encompass a plant with its original whole skeletal structure, namely, without applying any crushing, grinding, powdering etc., of the plant or of at least the plant's fronds. The term whole fresh plant encompasses whole cells and intact or integral cells or cell structure or essentially intact plant.

The term “integral fresh pulp juice” is to be understood to encompass a green water suspension with a solid content of 1-15%, preferably with a solid content of 2-10%, and more preferably with a solid content of 3-8%, resulted by plant cell disruption process, with and/or without concentration step, using methods and equipment known in the art [Yosuf C. et al. 1986; Santos da Fonseca R. A. 2011] with nutritional facts similar to that presented in Table 1.

The term “powder dry plant” is to be understood to encompass a green powder resulted from “whole plant” dried using any conventional and industrially acceptable methodology, this includes drying in the sun, by a heating device such as an oven, freeze-drying, spray drying, fluidized bed, vacuum drying, capillary extraction or combination thereof, using the procedures and equipments known in the art [Enachescu-Dauthy, M. 1995; Jangam S. V. ET AL. 2010], with a moisture content of 2-10%, preferably a moisture content of 3-8% and more preferably a moisture content of 4-6% and then by grinding, have a maximum dimension of particle size with values in the range of 20 to 100 microns, preferably in the range of 30-80 microns, and more preferably in the range of 40-60 microns.

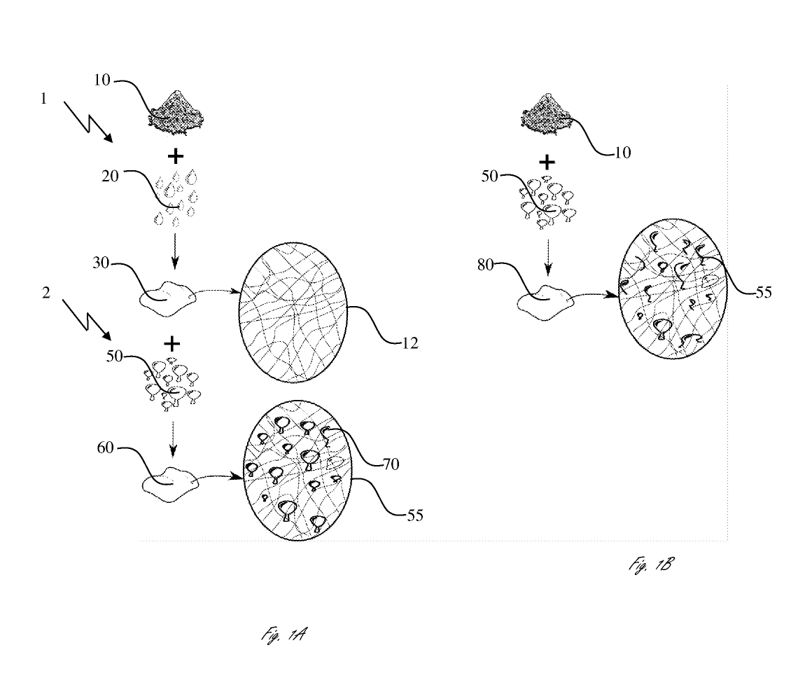

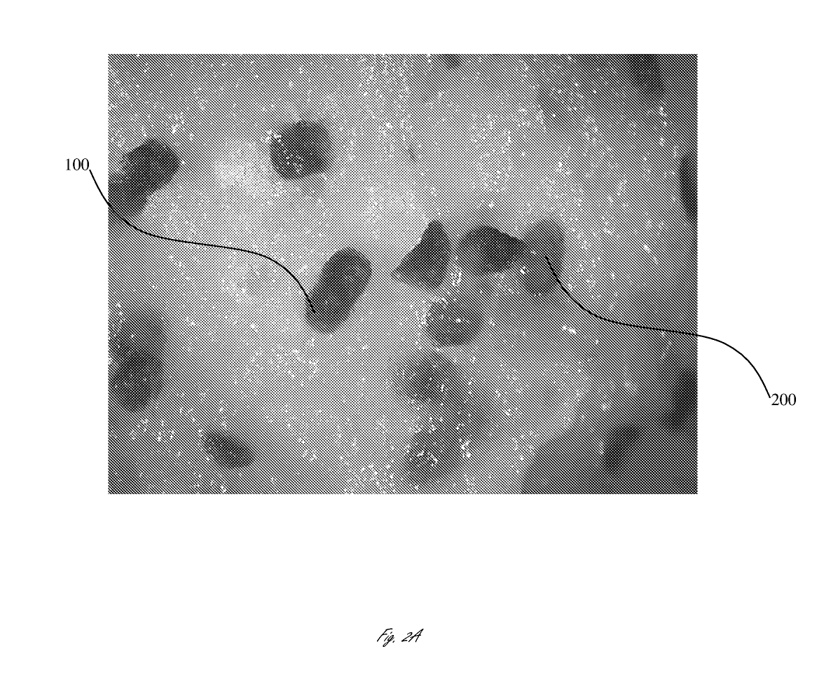

The term “disrupted plant” or “disrupted plant cell(s)” generally refers to plant part or particulate plant material or pieces of plant or cell debris. It is to be understood as referring to a plant after being subjected to at least one processing step that resulted in the disruption of the cellular structure of the plant, for instance, grinding, crushing or subjecting the plant to shear forces, as well as subjecting it to extraction processes. In some embodiments, the disrupted plant material encompasses one or more of fractionated cells or cells wherein at least part of their suspension content has been extracted during the kneading process with flour, to be absorbed and interacted by the flour to form the dough. FIGS. 1B and 2A clearly demonstrates several whole cells (100) which are relatively smaller in volume, and several disrupted cells (200), clearly distinguishable in the micrograph. In FIGS. 1A and 2B, it can easily be seen that at the same magnification, very little if any cellular disruption has occurred.

It is herein acknowledged that the dough kneading process disrupts the plant as the flour particles rub against the plant cells and intercellular liquid is released. This type of dough kneading is therefore termed “plant disruptive dough kneading process”.

The abovementioned dough illustrated in FIGS. 1A and 2B behave mechanically similar to conventional dough (absent of plant) as described in the examples 1-6.

The term “essentially” as used herein means being part of the nature or essence of something, i.e. the dough; or fundamentally important or necessary for the formation of something, i.e. of the dough. In the context of the present invention, the liquid component of the dough (it is common knowledge that dough is made from a solid component, i.e. flour and a liquid component, i.e. water) surprisingly essentially originates from fresh whole Wolffia family plant, to which is added the dry material during the kneading process It is emphasized that the scope of the present invention further includes adding an insignificant amount of water or any other liquid, before, during or after the kneading process with flour, in addition to the fresh whole plant. In certain aspects, such insignificant amount of water may be up to about 20% of the liquid component required to form dough of flour.

The terms “post kneading” or “after characteristics of dough have been substantially attained” are to be understood in the context of the present invention to refer to the mixing of the ingredients and kneading until the stage of uniting the ingredients and then additional mixing until reaching the step of dough formation. In bread dough, after the ingredients unite there is a need for the dough to develop a gluten network. Hydrogen bonds expand with liquid absorption. The yeast cut the bonds which cause the protein to close and look like a yarn ball. Kneading opens the protein and enables future water release as a result of the heat (in the oven) while still preserving the structure of the dough having bubbles.

In fresh pasta dough one should be careful not to proceed to the opening stage after uniting the ingredients. If crossing this stage the dough is designated to cook. While cooking it swells a little bit and its specific gravity changes and it floats on water. If such a process does happen (swelling) the dough will lose its holding ability and disintegrate.

The test: after forming the dough if after pressing on the dough it returns to its original shape—this means forming a gluten network has ensued.

Reference is now made to FIG. 1 presenting a schematic illustration of the dough of the present invention and method for its preparation in comparison with exemplary prior art dough. FIG. 1A is a prior art example, illustrating the outcome of the following steps:

Step 1: An appropriate amount of flour (10) and water (20) are combined and kneaded to form a dough (30). The dough is defined by a mesh structure (40) i.e. in the case of regular flour, is a glutein mesh, which provides dough its characteristic properties.

Step 2: Wolffia (50) is added to the dough which has already formed (30). Only a relatively small proportion of Wolffia is disrupted (55), as seen in the resulted mesh 70.

It should be noted that a similar outcome may be achieved when steps 1 and 2 are performed simultaneously.

In FIG. 1B, which is the core of the present invention, Wolffia (50) is combined with the flour (10), no additional water (or very little) is added, the Wolffia and the flour are combined and kneaded (1), particles of flour “rubbing” against the Wolffia disrupts a large proportion of the plant cells (55), plant liquid leaks out of the disrupted cells, providing a sufficient amount of liquid to react with the flour in order to generate dough (80), with its specific characteristics.

It is further within the scope that the fresh whole plant is added to flour to generate the dough by releasing the liquid from the plant cells and causing disruption of plant cells during the kneading process. This means that the plant component is added prior to the dough formation as the liquid component, replacing water. It is again emphasized that dough destined to be made into bread may have different characteristics than dough intended for pasta, yet in both cases, dough has specific physico chemical properties and mechanical properties and rheological properties. Such properties are defined, and are brought into being by the kneading process. A combination of flour and liquid prior to kneading does not have typical dough characteristics, and dough is defined herein as that which has already been kneaded and is now endowed with characteristic dough like properties herein described. If, plant or plant liquid component is added after dough formation, or in addition to the water component of the intended dough, an inspection of a micrograph will reveal less plant cell disruption than would be noted in the case when an equivalent amount of plant would be added to flour prior to completion of kneading and dough formation.

The plant material may be characterized by its color range. Various members of the Duckweeds family have different colors or color ranges. When referring to a color or color range it is to be understood as encompassing also variations within the color in its hue, chroma, saturation, intensity, lightness, value, tone or brightness, tints or shades (e.g. being mixed with white or black hue).

For instance, and without being limited thereto, when considering Duckweeds family to include any member of the genus Spirodela, Landoltia, Lemna, Wolffiella, and Wolffia, these may be distinguished by their different color. While, for example, Spirodela is characterized by a red anthocyanin pigment providing the plant with a red purple, or blue (i.e. red or near red) color, Wolffia on the other hand may be characterized by a green color or near green color.

In some embodiments, the plant color range is selected from a green pigment range, red pigment range or yellow pigment range. In some other embodiments, e.g. when the plant material is Wolffia, the plant color is green or near green.

Thus, when referring in the context of the present disclosure to a plant color range and to a mass having a mass color falling within the plant color range or near the plant color range it is to be understood that when employing, for the preparation of the dough, a duckweeds with a particular pigment range, the dough mass will obtain the same or spectrally near color.

As a non-limiting example, the plant may be a member of the Wolffia genus, including, and without being limited thereto, Wolffia angusta, Wolffia arrhiza, Wolffia australiana, Wolffia borealis, Wolffia brasiliensis, Wolffia columbiana, Wolffia cylindracea, Wolffia elongata, Wolffia globosa, Wolffia microscopica, and Wolffia neglecta are all characterized by a green or near green pigment, as a result of the chlorophyll present in the plant. Without being bound by theory, the changes in the color of dough which contains the plant may be due to the formation of a chlorophyll-complex (e.g. non-covalent bonding) with biopolymers such as polysaccharides and proteins.

In this context, and without being limited thereto, the term “green color” denotes a color or color range between yellow and blue in the visible light spectrum, having a wavelength or range of wavelengths falling between about 495 nm to 570 nm with the “near green” being defined as any deviation from the green color of about 20 nm to about 100 nm.

Similarly, when referring to red or near red color it is to be understood as a plant having a pigment within the wavelength or range of wavelengths of between 620 to 750 nm, with a deviation from this range of between 20 nm to 100 nm (i.e. the near red color).

Further, similarly, when referring to yellow or near yellow color it is to be understood as a plant having a pigment within the wavelength or range of wavelengths of between 570 to 590 nm, with a deviation from this range of between 20 nm to 100 nm (i.e. the near yellow color).

Liquid component, in some embodiments of the present invention, refers to liquid essentially originating from fresh whole Wolffia genus plant, whether the liquid is within the plant cells or after it has been released from the plant cells due to disruption. In some cases it is acknowledged that additional liquid, such as water may be added in small quantities in an amount which does not significantly effect the disruption of the plant cells during the kneading process.

TABLE 1
Nutritional Facts of Fresh Wolffia arrhiza (HINOMAN)

| | | Fresh |
|---|---|---|
| | UM | Wolffia arrhiza |
| General Chemical Composition | | |
| Water | g/100 g serving | 94 . . . 96 |
| Protein | g/100 g serving | 1.9 . . . 2.1 |
| Total Fat | g/100 g serving | 0.07 . . . 0.09 |
| Total Carbohydrate | g/100 g serving | 2.1 . . . 2.5 |
| Dietary Fiber | g/100 g serving | 0.17 . . . 0.19 |
| Ash | g/100 g serving | 0.5 . . . 0.7 |
| Calories | kcal/100 g serving | 16 . . . 19 |
| Essential AA | | |
| Histidine | g/100 g serving | 0.035 . . . 0.042 |
| Isoleucine | g/100 g serving | 0.044 . . . 0.051 |
| Leucine | g/100 g serving | 0.095 . . . 0.11 |
| Lysine | g/100 g serving | 0.07 . . . 0.08 |
| Methionine | g/100 g serving | 0.01 . . . 0.015 |
| Phenylalanine | g/100 g serving | 0.06 . . . 0.07 |
| Threonine | g/100 g serving | 0.05 . . . 0.06 |
| Tryptophan | g/100 g serving | 0.032 . . . 0.034 |
| Valine | g/100 g serving | 0.06 . . . 0.07 |
| Vitamins | | |
| Vitamin A(as beta-carotene) | mg/100 g serving | 1.1 . . . 1.3 |
| Vitamin B6 | mg/100 g serving | 0.012 . . . 0.014 |
| Vitamin B12 | mg/100 g serving | 0.25 . . . 0.29 |
| Vitamin C | | |
| Vitamin D | | 0 |
| Vitamin E (Alpha-tocopherol) | mg/100 g serving | 1.2 . . . 1.4 |
| Vitamin K | | |
| Vitamin B1 (Thiamin) | | |
| Vitamin B2 (Riboflavin) | mg/100 g serving | 0.13 . . . 0.16 |
| Vitamin B3 (Niacin) | | |
| Minerals | | |
| Calcium | mg/100 g serving | 20 . . . 30 |
| Iron | mg/100 g serving | 4 . . . 8 |
| Magnesium | mg/100 g serving | 20 . . . 30 |
| Phosphorus | mg/100 g serving | 70 . . . 90 |
| Potassium | mg/100 g serving | 160 . . . 230 |
| Sodium | mg/100 g serving | 3 . . . 9 |
| Zinc | mg/100 g serving | 0.7 . . . 1.1 |
| Copper | mg/100 g serving | 0.08 . . . 0.12 |
| Manganese | mg/100 g serving | 1 . . . 3 |
| Boron | mg/100 g serving | 0.2 . . . 0.4 |

The plant component of the composition of present disclosure, replace the traditional function of the liquid within the dough's formulation from which yeast and non-yeast bakery, pasta and wet pasta products are prepared, in a proportion correlated with the specifics of the bakery and pasta's products (with moisture content in the range 5-60%). The flour and plant can be expressed by ratio flour:plant as dry weight basis with values in the range from 98:2 by dry weight basis up to 42:58 by dry weight basis. Preferably the ratio flour:plant as dry weight basis in range from 97:3 by weight dry basis up to 55:45 by dry weight basis and much more preferable with values in the range from 95:5 by weight dry basis up to 65:35 by dry weight basis.

The ratio flour:plant by dry weight basis can be found in all kinds of forms of dough for the preparation of bakery and pasta products, being associated with other components that are used for these kind of food products as well: water, salt, milk, yeast (yes or no), oil or fats and the like.

The combination of the components of the invention includes a traditional flour for all types of bakery and pasta products including the various types of wheat flour: regular flour usually used in breads, whole flour, buckwheat flour (gluten free), durum wheat, and also other kinds of flour such as rice flour, rye flour, oat flour, corn flour, teff flour, and mixtures of flour.

The dough is the most important intermediary product which results from the adopted formulation for any bakery and pasta product, but especially for the yeast bakery and pasta (or fermented materials). The simplest formulation is made of flour and water. By mixing the two components of formulation, takes place the transformation of aqueous suspension in a material entity which posses a unique rheological characteristics, called sourdough.

Forming the dough is a complex physico-chemical process, dominated by the interaction between the biopolymeric components of flour (proteins and polysaccharides), the foremost being the solvation phenomena which occurs simultaneously with the manifestation of intense tangential tensions (evolved during mixing), which at their turn induce mechano-chemical processes that are translated by altering of the macromolecular configuration specific for gluten.

Regardless of the process used in the preparation of such bakery and pasta products, it is critical to properly develop the dough. This is primarily a result of the protein of flour, which is gluten, becoming hydrated and forming elastic films. Wetting the flour during dough-making, permits to the gluten protein to absorb water and to swell, thereby weakening some of the intermolecular forces holding the adjacent protein chains together. As mixing proceeds, the protein chains are stretched and unwound and by means of interchange reactions between disulfide bonds under stress and adjacent sulfhydryl groups, a network of protein chains is developed.

The type of flour (wheat, rye, oat etc.) and its quality (chemical composition, granulometry etc.) together with the quantity of water used (expressed as percent related to flour), mixing mechanics (gear geometry, speed of moving bodies) and mixing time are major factors that control the rheological properties of the material entity called dough [Simpson B. K 2012].

Inclusion in the basis formulation (flour and water) of other components determines the modification of dough's rheology, in the conditions when the other factors mentioned above keep their adopted values.

The plant component as whole fresh plant or integral fresh pulp juice of the composition components of the invention, destined to obtain a bakery and pasta product are partially or full water sources for the preparation of dough.

The amount of liquid from the dough with the plant component, which is the object of this invention, has values in the range of 55-85%, preferably between 60-80%, and more preferably in the range of 65-75%, relative to the mass value corresponding to the amount of flour and plant, both measured as dry materials. These percentages result from the ratio flour:plant designed for the dough formulation.

The term “water from whole fresh plant or integral fresh pulp juice” shall be understood as an aqueous solution of natural components (e.g. proteins, carbohydrates, vitamins, antioxidants) contained in the structure of the aquatic plant selected for this invention, at intra- and inter-cellular level.

When the whole fresh plant is used as water source, the aqueous solution of natural components is released from the plant as a result of the manifestation of two distinct phenomena:
sorbtion of liquid phase from a material as gel type (the plant) by a solid absorbent medium represented by flour, based on mass transfer phenomena generated by the difference of concentration of liquid phase, associated with the difference in chemical affinity toward the water between the two components [Ocieczek A. 2012];
diminish of mechanical resistance of aquatic plants of the Lemnaceae family at intense abrasion generated by the particles of flour (with irregular shape and sharp asperities at surface [Arany C. et al. 1968]) resulting in the appearance of cell disruption process facilitating the extraction.

The sensitivity to abrasion of aquatic plant Wolffia arrhiza, preferred for this invention, was confirmed through a simple experiment that consisted of mixing an aqueous suspension of whole fresh plant to a ratio plant:water with values ranging from 1:1 up to 1:5 in mixing conditions with the agitator anchor type at velocities from 100 rpm up to 500 rpm for 10 minutes. The suspension resulted has been centrifuged at 1500 g for 5 minutes. Clear phase collected have been analyzed from the point of view of: the concentration of extract; mass loss versus the solid from fresh Wolffia; electroconductivity of extract and color of extract (extinction at 620 nm). The results obtained are mentioned in Table 2 and Table 3. The data from Table 2 and Table 3 confirm the loss of morphological integrity of the plant at intensifying friction between plants.

The plant components: “whole fresh plant” and “integral fresh pulp juice”, as source of water for the dough making, represents a technological innovation which has the following advantages:
keeping the physico-chemical properties and biochemical properties of substances contained in the plant, which will confer to bakery and pasta products better nutrition facts;
aqueous solution that participate to the preparation of the dough contains natural components (saccharides and oligosaccharides, proteins and emulsionable fat-like compounds as pigment-protein complex and fat-protein complex) that can function as traditional ingredients added to the basis formulation of dough, both for yeast and non-yeast bakery and pasta products;
a part of the natural components contained in the aqueous solution resulted from the whole fresh plant and integral fresh pulp juice, having a macromolecular feature [Maznah I. 1998], will interact with the biopolymers specific to flours resulting a “hardening” of the dough (increasing of consistency), that will translate by reducing of stickyness of mixing and the improvement of handling.

Technological particularity of the dough resulting from formulations containing flour and whole fresh plant, consist in the fact that preparation time is greater than the corresponding one to formulation from flour and water.

It is herein acknowledged that hydration of flour results in the formation of a visco-elastic dough (i.e. both elastic and extensible). The rheology of dough is attributable to: 1) gluten proteins (i.e. gliadin and glutennin). The long chain Glutennin chains have extensive sites for cross linking and therefore contribute mainly to dough elasticity; 2) bonding (intra and intermolecular) interactions contribute to dough elasticity or rigidity.

The preparation of the dough (with or without the plant material) requires a defined ratio between the liquid in the dough and the total dry material in the dough. In this context, the term “total dry material” encompasses the amount of flour and the amount of plant material when measured in dry form. The amount of dry plant material may be determined as described above for determining liquid content within the plant.

One may use a weight % ratio between the liquid and total dry material. In some embodiments, the liquid to total dry material in the dough may be between 55% to 85%, at times between 60% to 80%, and even between 65% to 75%.

The dough may be further characterized by its farinographic characteristics (also regarded as the dough's rheological parameters). A farinograph is a common physical dough-testing instrument used to determine different characterizations of dough, such as the plasticity and mobility of the dough. The farinograph defines a dough farinographic profile with the vertical axis being in farinograph units (FU) (at times also in Brabender Units (BU)) as a function of time in minutes.

TABLE 2
The influence of the velocity upon the morphological
integrity of Wolffia arrhiza plant

| | Water extract | | | |
|---|---|---|---|---|
| | fresh Wolffia:water = 1:5 by weight | | | |
| | | | | Color of |
| solid/100 g fresh | Extract | Solid | EC of | extract |
| Wolffia 4.74 | concentration | loss/DM | extract | (620 nm) |
| rpm/10 min/22° C. | g/100 g | % | microS | extinction |
| 100 | 0.053 | 1.23 | 53 | 0.015 |
| 300 | 0.075 | 3.15 | 245 | 0.061 |
| 500 | 0.142 | 5.99 | 302 | 0.078 |

TABLE 3
The influence of suspension concentration of
Wolffia arrhiza on its morphological integrity

| | Water extract | | | |
|---|---|---|---|---|
| | 100 rpm/10 min/22° C. | | | |
| solid/100 g fresh | | | | Color of |
| Wolffia 4.74 | Extract | Solid | EC of | extract |
| fresh Wolffia:water | concentration | loss/DM | extract | (620 nm) |
| by weight | g/100 g | % | microS | extinction |
| “1:1” | 0.008 | 0.12 | 138 | 0.037 |
| “1:2” | 0.012 | 0.25 | 112 | 0.031 |
| “1:3” | 0.021 | 0.63 | 90 | 0.025 |
| “1:4” | 0.026 | 0.92 | 65 | 0.019 |
| “1:5” | 0.053 | 1.23 | 53 | 0.015 |

Reference is now made to FIG. 2, demonstrating the clear distinctions between the dough of the present invention generated by kneading essentially flour and fresh whole Wolffia (FIG. 2A) and dough prepared by kneading flour and water, and the fresh whole Wolffia component is added only after characteristics of the dough have been substantially attained (FIG. 2B). This figure illustrate microscopic pictures generated under the same scale (X45), of dough prepared with similar flour to liquid content, subjected to different treatments as detailed above. It can be seen from this figure that in FIG. 2A, as a result of kneading essentially flower and fresh whole plant, without adding water, or adding an insignificant amount of water (i.e. up to about 20% of the liquid component required to form the dough) more shrived and smaller and more faint and brighter frond like structures are generated (200), leading to a greener colored dough. More particularly, in the dough of the present invention (FIG. 2A), the ratio between whole plant cell structures or integral or intact plant biomass or fronds (100) to disrupted cells or disrupted cell structures or cell debris (200) is about 1:1 and in other embodiments the proportion of disrupted plant cells is higher, i.e. about 50% higher than intact or integral plant cell structures, in a statistically represented unit. It can be seen the whole plant cell structures or integral or intact plant biomass of the dough of the present invention (FIG. 2A) is shrived and smaller in volume relative to the whole plant structures in FIG. 2B. It is noted that the cell disruption process during the kneading is performed in order to extract the plant cell suspension content which is used as the source of liquid, essentially replacing water, in forming the dough.

In comparison with the dough of the present invention (FIG. 2A), the dough presented in FIG. 2B, shows only whole fronds or whole plant structures with a higher volume and a higher green color (300). The dough of FIG. 2B is whiter since almost no cell suspension has been released from the whole plant cells. In this dough, which was not exposed to the treatment of the present invention, namely, kneading flour and fresh whole plant as the source of liquid to generate the dough, the ratio observed post kneading or after characteristics of the dough have been substantially attained, between whole plant cell structures or whole fronds to disrupted plant cells or cell debris is significantly higher, i.e. at least 50% higher than the ratio observed in the dough of the present invention (FIG. 2A).

The formulations for yeast dough bakery and pasta products use leavening agents (also known as “leaveners”).

The term “leavening” is to be understood by its meaning acceptable in the art, namely, the foaming process softens and lightens the finished dough. Accordingly, a “leavening agent” is to be understood as any agent that initiates such a foaming process and this includes biological leaveners and chemical leaveners (baking soda or baking powder, baker's ammonia, potassium bicarbonate).

In accordance with the present disclosure, the leavening agent within the combination is a biological leavening agent, namely, any product comprising microorganisms that, as part of their lifecycle, ferment sugars in the food to thereby produce and release carbon dioxide.

Without being limited thereto, some non-limiting biological leavening agents include unpasteurized beer, buttermilk, ginger beer, kefir, sourdough starter, yeast, whey protein concentrate and yogurt.

In some embodiments, the leavening agent is yeast, including, without being limited thereto, fresh yeast, active dry yeast, and instant yeast.

A non limiting example of yeast used in the present invention for forming yeast bakery products is bakers fresh dough yeast formulation, presented in FIG. 30.

The traditional formulations of dough for yeast bakery and pasta products, which use ordinary types of flour (wheat, rye or oat) contain leavening agent (expressed as commercial dry yeast) at a rate of 0.5-5% related to flour, preferably for being 1.5-2.5%.

The composition with plant component, that is the object of the present invention, may include with non-limiting criteria, any other traditional ingredients used in the preparation of yeast and non-yeast bakery and pasta products.

To prepare the dough are known in art several methods of processing, the following being representative [Stear C A. 1990; Belitz H.-D. et al. 2009]:
one step mixing of all formulation's components together;
two or more steps mixing, in variant when the entire formulation is divided into several parts and are incorporated successive, at various intervals of time, or in the variant with realization of several pre-mixtures containing some of the components of formulation, when after a preparation time of the first pre-mix is added successively, at specific intervals of time, the rest of pre-mixtures.

The process of preparing of the combination of components as dough, of the invention, is dependent on the type of plant component that is used.

The process of dough preparation that uses whole fresh plant or integral fresh pulp juice, for getting yeast bakery and pasta products, consists of:
dosing of specific components (flour, plant, leavening agent and salt, and other optional ingredients) in the space of mixing equipment selected for the realization of process;
mixing of the formulation an interval of time called “dough development time” according to obtain a material entity as elasto-plastic type (the dough itself), unitary and homogeneous, with values in the range of 3-30 minutes, preferably in the range of 4-20 minutes and much more preferable in the range of 5-10 minutes, in conditions of constant temperature with the value between 25 to 30° C., and constant mixing regime according to the equipment available in the series: high mixing, medium mixing or low mixing, so that kneading of the dough is at a velocity of between 10 to 150 rpm, preferably between 30 to 60 rpm.

Preparation of the dough which uses powder dry plant, for getting yeast and non-yeast bakery and pasta products, can be done by applying any of the techniques well known in the art, as they have been outlined above.

Further processing of the dough is made, too, by applying the procedures known in art, which have already been mentioned.

The present invention further provides a food product comprising the dough as described in any of the above.

It is further within the scope of the present invention to provide a method of preparing a malleable mass of dough comprising steps of: (a) obtaining dry material; said dry material comprises flour; and, (b) obtaining a liquid component; said liquid component comprising liquid essentially originating from fresh whole Wolffia genus plant. It is also within the scope that the aforementioned method additionally comprising steps of kneading said dry material with said fresh whole Wolffia genus plant to disrupt at least part of said fresh whole plant thereby extracting said liquid component from said fresh whole plant, such that the post kneaded ratio of said whole fresh plant to disrupted plant is at least 50% lower than a corresponding dough comprising same ratio of dry material to liquid component defined as water, said corresponding dough is further characterized by: (i) Wolffia added post kneading, or (ii) Wolffia added after characteristics of dough have been substantially attained, or (iii) Wolffia added in addition to the liquid component of said dough, or any combination thereof.

It is further within the scope of the present invention to provide a method of preparing a food product comprising steps of providing a dough as described in any of the above and processing said dough, said processing is selected from the group consisting of combining the dough with a food ingredient, rising, kneading, extruding, molding, shaping, cooking, stewing, boiling, broiling, baking, frying and any combination of same.

While the invention has been illustrated and described as embodied in a composition utilizing duckweed plant component for dough preparation and method for making, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

In order to understand the invention and to see how it may be implemented in practice, a plurality of preferred embodiments will now be described, by way of non-limiting example only, with reference to the following examples.

### Example 1

This example shows the influence of partial replacement of flour with Wolffia arrhiza, as whole fresh plant, on the preparation of the dough.

Two formulations have been used, according to the data of Table 4.

TABLE 4
Recipes for Dough-1 and Dough-2 preparation

| | UM | Dough-1 | Dough-2 |
|---|---|---|---|
| Total mass | g | 474 | 474 |
| Flour¹⁾ | g | 300 | 290.8 |
| Water²⁾ | g | 174 | 0 |
| Plant: | g | 0 | 183.2 |
| (solid) | g | — | 9.2 |
| (water) | g | — | 174 |

¹⁾Wheat flour, white, all-purpose “WF-0513” from CEREAL MILL OF ISRAEL, Bnei Brak, with the following chemical composition: ash = 0.5; protein = 10.9%; moisture = 12.2%; calcium = 14.2 mg/100 g; iron = 4.3 mg/100 g
²⁾Whole fresh plant Wolffia arrhiza, from HINOMAN with the chemical composition: ash = 0.64%; protein = 1.98 percent; moisture = 95%; calcium = 27.8 mg/100 g; iron = 7.8 mg/100 g

For the preparation of dough, the “one step” procedure has been used, when all the components of the formulations were introduced into the kneader's farinograph before mixing.

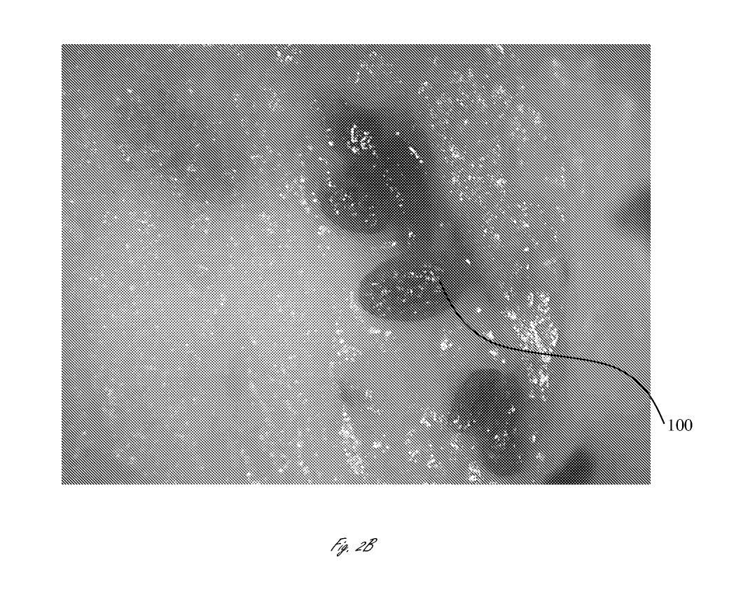

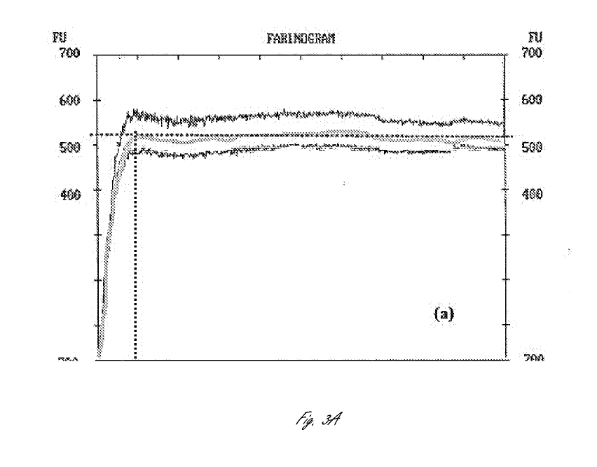

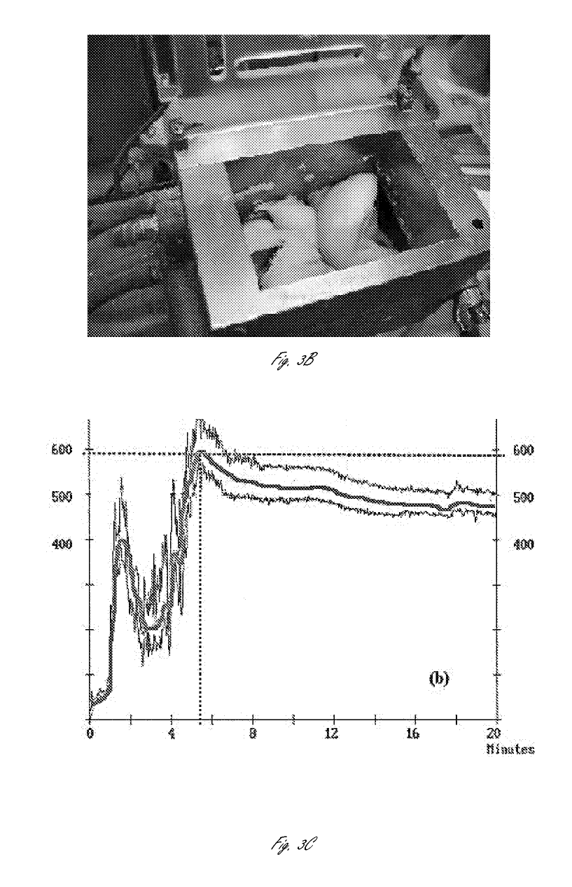

The farinograph curves corresponding to the preparation of dough by the two formulations are shown in FIGS. 3A and 3C, and their rheological parameters are mentioned in Table 5.

TABLE 5
Characterization of Dough-1 and Dough-2

| | UM | Dough-1 | Dough-2 |
|---|---|---|---|
| DT | min | 1.9 | 5.2 |
| C | FU | 514 | 598 |
| S | min | 19 | 2 |
| DS | FU | 3 | 88 |

The formulation of the dough with whole fresh Wolffia, for which the ratio flour:plant by dry weight basis is 97:3, and the amount of water used for preparation is 585 g related to flour, allows getting the dough's rheological character of the mixture (DT) in 5.2 minutes, which is 2.73 times higher than the development time of the formulation that does not contain the plant.

Stability of dough with plant is only 2 minutes, much lower than the mixture without the plant, and the degree of softening is 88 FU for Dough-2, and for Dough-1 is only 3 FU.

The dough with the plant has a light green color, different from the dough without plant (FIGS. 3B and 3D) and a morphology of bi-phase type wherein you can see dots of intense green color distributed in the green light phase. Changing the color of dough which contains the plant is explained by the chlorophyll-protein complex content in the aqueous solution extracted from the whole fresh Wolffia, with the dye properties, capable to interact with biopolymers from flour (polysaccharides and proteins), with preferential formation of non-covalent bonds.

The evaluation at optical microscope of the size of intense green dots has been ascertained the fact that they represent the plant material fractions or parts (the average diameter of 0.6 mm) smaller than the one suitable for whole fresh Wolffia (the plant has an average diameter of 1 mm) This result proves the existence of partial cell disruption process suffered by vegetal biomass during dough preparation simultaneously with the sorption of liquid phase from “vegetal gels” through the sorbent represented by flour, followed by the contraction of plant's individual volume.

### Example 2

This example shows the influence of water content adopted for the formulations of the dough, with and without the plant. The formulations used in this example are presented in Table 6.

TABLE 6
Recipes for dough preparation (Dough-3 to Dough-6)

| | UM | Dough-3 | Dough-4 | Dough-5 | Dough-6 |
|---|---|---|---|---|---|
| Total mass | g | 474 | 474 | 474 | 474 |
| Flour | g | 304 | 295 | 296 | 286.6 |
| Water | g | 170 | 0 | 178 | 0 |
| Plant: | g | 0 | 179 | 0 | 187.4 |
| (solid) | g | — | 9 | — | 9.4 |
| (water) | g | — | 170 | — | 178 |

Rheological parameters adequate to Dough-3 to Dough-6 preparation are mentioned in Table 7.

TABLE 7
Characterization of Dough-3 to Dough-6

| | UM | Dough-3 | Dough-4 | Dough-5 | Dough-6 |
|---|---|---|---|---|---|
| DT | min | 2.1 | 5.8 | 1.7 | 5.1 |
| C | FU | 623 | 631 | 501 | 582 |
| S | min | 14 | 2.2 | 18.3 | 1.5 |
| DS | FU | 36 | 114 | 0 | 106 |

Using a quantity of water in the formulations for dough preparations without plant, which represents 56% related to flour (Dough-3) and 60% related to flour (Dough-5) lead to materials with a difference in consistency more than 120 FU. A significant difference is also found with respect to the other rheological indicators.

By replacing an amount of flour with the corresponding amounts of whole fresh Wolffia, so they (as a source of water) can provide the same amount of water as the formulations without plants, a phenomenon of “hardening” of the material is observed, confirmed by the consistency values. At the water content of 56%, the hardening effect induced by plant represents a consistency growth of only 1.2%, while at a water content of 60% the effect of hardening represents an increase of 16.1%.

Experimental data for consistency sustain the fact that the whole fresh plant in formulations intended for dough making bakery and pasta products, assure themselves the necessary water for the dough, without being required to add supplementary water. It is also demonstrated that an aqueous solution released by the plant interacts with biopolymeric components of flour easier, as the viscosity of the initial mixture is lower.

### Example 3

This example shows the influence of the intensity of cell disruption process on the formation of the dough.

A new dough called Dough-6A, has been prepared with the same recipe as the Dough-6 (Table 6) detailed above, except that, after dosing components in the farinograph's vessel, they were mixed for just 1 minute for homogenization of the two solid phases, then the mixture was removed from the device, placed in a kitchen metallic tray, covered with a plastic sheet and finally entered into a laboratory incubator with a temperature adjusted at 30° C. After 60 minutes, the mixture (upon not having been practiced by any kind of mechanical actions) has been removed from the incubator and introduced into the farinograph.

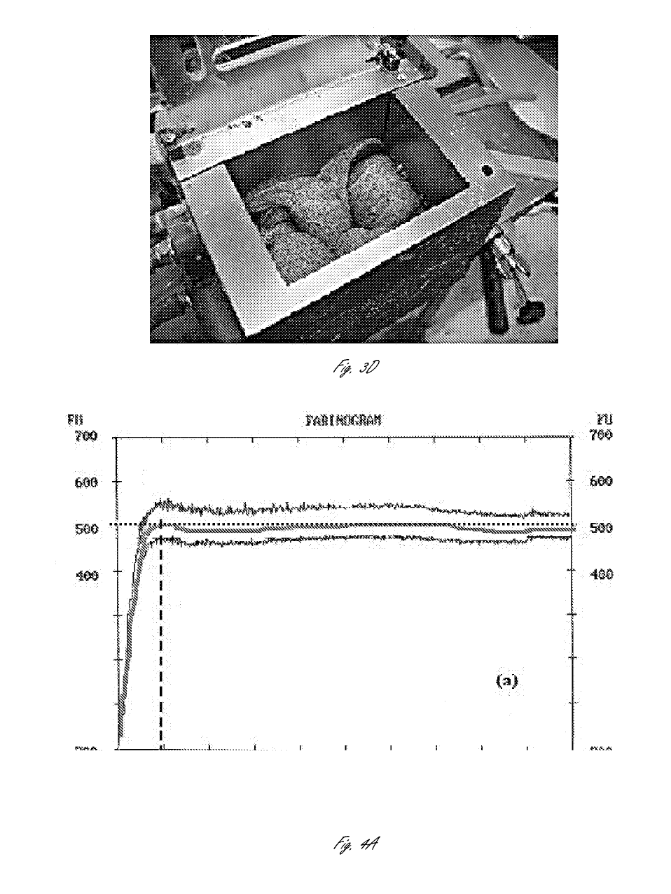

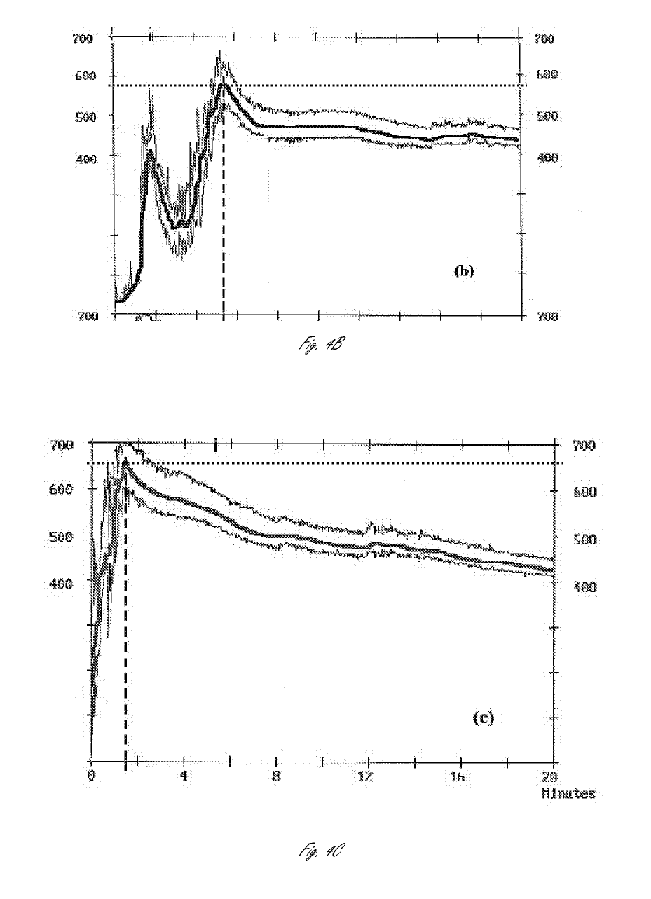

Rheological properties of the Dough-6A sample, compared to those of Dough-5 and Dough-6 are presented in FIG. 4.

A farinograph curve of Dough-6A (FIG. 4C) shows that the material has characteristics of dough after only 1.5 minutes of mixing, with a consistency of 663 FU, much higher than for Dough-5 (FIG. 4A) and Dough-6 (FIG. 4B). Without wishing to be bound by theory, this result is interpreted as follows:
in the absence of mechanical efforts the wheat flour functions as an absorbent in relation to vegetal gel particles belonging to the whole fresh Wolffia, extracting one part from liquid medium content in plant;
by absorbing the liquid medium, the particles of flour swell, resulting in a more or less continuous gel, consisting of a reactive biopolymeric network formed through non-covalent bonds.
reactive-tridimensional network of flour, “wraps” the corresponding plant particles, without breaking the cell walls, interact with the plant particles, resulting in a macromolecular composite that can be associated with semi-IPN [Manson J. A., 1976];
due to the fact that the volume of the extracted liquid medium is insufficient for a properly solvation of gluten, the resulted material is “hard”.
at the intervention of tangential tensions exerted by sigma mixer of farinograph, the semi-IPN configuration is degraded gradually, continually, with releasing of an additional quantity of liquid medium from the plant, due to processes of cell disruption events.

### Example 4

In this example, innovative pasta dough comprising flour and fresh plant is demonstrated.

The terms “pasta” or “noodles”, especially “wet pasta” or “wet noodles”, refer hereinafter in a non-limiting manner to an edible product shaped e.g., in one or more elongated or rounded or twisted or chopped or tied or folded shapes, such as those selected from a group consisting of Spaghetti-like shape, namely a long, thin, cylindrical, pseudo-cylindrical or polygonal cross section; noodle-like shape, namely a long and very thin shape; Barbina-like shapes, namely Thin strands often coiled into nests, Little beards; Bigoli-like shapes, namely Thick tubes; Bucatini-like shapes, namely A thick spaghetti-like product with a hole running through the center; Capelli d'angelo-like shapes, namely A synonym of capellini, they are coiled into nests; Capellini-like shapes, namely The thinnest type of long product; Fusilli-like shapes, namely Long, thick, corkscrew shaped product that may be solid or hollow; Fusilli bucati-like shapes, namely Long coiled tubes that are hollow; Perciatelli which are identical to bucatini; Pici-like shapes, namely Very thick, long, hand rolled producy; Spaghettini-like shapes, namely Thin spaghetti; Vermicelli-like shapes, namelya traditional product round that is thicker than spaghetti; Vermicelloni-like shapes, namely Thick vermicelli which are Large or little worms-like products; Ziti-like shapes, namelyLong, narrow hose-like tubes sized smaller than rigatoni but larger than mezzani; Zitoni-like shapes, namely Wider version of Ziti; Zitoni-like shapes, namely Large ziti; Biángbiáng noodles like shapes, namely Very wide ribbon cut rice noodles; Ciriole-like shapes, namely Thicker version of chitarra; Fettuce-like shapes, namely Wider version of fettuccine; Fettuccine-like shapes, namely Ribbon of product approximately 6.5 millimeters wide; Fettucelle-like shapes, namely Narrower version of fettuccine; Lagane-like shapes, namely Wide noodles; Lasagne-like shapes, namely Very wide noodles that often have fluted edge; Lasagnette-like shapes, namely Narrower version of lasagna; Little lasagne-like shapes, namely Longer version of lasagna; Linguettine-like shapes, namely Narrower version of linguine; Linguine-like shapes, namely Flattened spaghetti; Mafalde-like shapes, namelyShort rectangular ribbons; Mafaldine-like shapes, namely Long ribbons with ruffled sides; Pappardelle-like shapes, namely Thick flat ribbon; Pillus-like shapes, namely Very thin ribbons; Pizzoccheri-like shapes, namely a type of short tagliatelle, a flat ribbon product; Sagnarelli-like shapes, namely Rectangular ribbons with fluted edges; Scialatelli or scilatielli-like shapes, namely Homemade long spaghetti with a twisted long spiral; Shahe fen-like shapes, namely Ribbon cut rice-like noodles; Spaghetti alla chitarra-like shapes, namely products Similar to spaghetti, except square rather than round; Stringozzi-like shapes, namely those Similar to shoelaces; Tagliatelle-like shapes, namely Ribbon, generally narrower than fettuccine; Taglierini-like shapes, namely Thinner version of tagliatelle; Trenette-like shapes, namely Thin ribbon ridged on one side; Tripoline-like shapes, namely Thick ribbon ridged on one side; Calamarata-like shapes, namely Wide ring shaped product Squid-like; Calamaretti-like shapes, namely Little squids-like products; Cannelloni-like shapes, namely Large stuffable cylindrical (tube) product; Cavatappi-like shapes, namely Corkscrew-shaped macaroni; Chifferi-like shapes, namely Short and wide macaroni; Ditalini-like shapes, namely Short tubes; Elicoidali-like shapes, namely slightly ribbed tube product, the ribs are corked as opposed to those on rigatoni; Fagioloni-like shapes, namely Short narrow tube; Fideuá-like shapes, namely Short and thin tubes; Garganelli-like shapes, namely a square shape rolled into a tube; Gemelli-like shapes, namely a single S-shaped strand of product twisted in a loose spiral; Gomiti-like shapes, namely Bent tubes; Elbows Maccheroncelli-like shapes, namely Hollow tube-shaped product that is slightly smaller than a pencil in thickness; Maltagliati-like shapes, namely a short and wide with irregular or diagonally cut ends; Manicotti-like shapes, namely large stuffable ridged tubes; Marziani-like shapes, namely Short spirals; Mezzi bombardoni-like shapes, namely Wide short tubes; Mostaccioli-like shapes, namely Similar to penne but without ridges; Paccheri-like shapes, namely Large tube product that may be prepared with a sauce atop them or stuffed with ingredients; Pasta al ceppo-like shapes, namely a sheet product that is similar in shape to a cinnamon stick; Penne-like shapes, namely Medium length tubes with ridges, cut diagonally at both ends; Penne rigate-like shapes, namely Penne with ridged sides; Penne lisce-like shapes, namely Penne with smooth sides; Penne zita-like shapes, namely Wider version of penne; Pennette-like shapes, namely Short thin version of penne; Pennoni-like shapes, namely a wider and thicker version of penne: a tube product with a diaganol cut on both ends; Rigatoncini-like shapes, namely Smaller version of rigatoni; Rigatoni-like shapes, namely Medium-Large tube with square-cut ends, sometimes slightly curved; Rotini-like shapes, namely product shape related to fusilli, but has a tighter helix, i.e. with a smaller pitch, Helix- or corkscrew-shaped product; Sagne 'ncannulate-like shapes, namely Long tube formed of twisted ribbon; Spirali-like shapes, namely a tube which spirals round; Spiralini-like shapes, namely More tightly-coiled fusilli; Trenne-like shapes, namely Penne shaped as a triangle; Trennette-like shapes, namely Smaller version of trenne; Tortiglioni-like shapes, namely Narrower rigatoni; Tuffoli-like shapes, namely Ridged rigatoni; Campanelle-like shapes, namelyFlattened bell-shaped product with a frilly edge on one end; Capunti-like shapes, namely Short convex ovals resembling an open empty pea pod; Casarecce-like shapes, namely Short lengths rolled into a S shape; Cavatelli-like shapes, namely Short, solid; Cencioni-like shapes, namely Petal shaped, slightly curved with rough convex side; Conchiglie-like shapes, namely Seashell shaped shells; Conchiglioni-like shapes, namelyLarge, stuffable seashell shaped; Creste di galli-like shapes, namely Short, curved and ruffled; Croxetti-like shapes, namely Flat coin-shaped discs stamped with coats of arms; Farfalle-like shapes, namely Bow tie or butterfly shaped; Farfalloni-like shapes, namely Larger bow ties; Fiorentine-like shapes, namely Grooved cut tubes; Fiori-like shapes, namely Shaped like a flower; Foglie d'ulivo-like shapes, namely Shaped like an olive leaf; Gigli-like shapes, namely Cone or flower shaped Lilies; Gramigna-like shapes, namely Short curled lengths of product Infesting weed, esp. scutch-grass; Lanterne-like shapes, namely Curved ridges; Lumache-like shapes, namely Snailshell-shaped pieces; Lumaconi-like shapes, namely Large snail shell-shaped pieces; Maltagliati-like shapes, namely Flat roughly cut triangles Badly cut; Mandala-like shapes; Orecchiette-like shapes, namely Bowl- or ear-shaped product; Pipe-like shapes, namely Very similar to Lumaconi but has lines running the length of it; Quadrefiore-like shapes, namely Square with rippled edges; Radiatori-like shapes, namely Shaped like radiators; Ricciolini-like shapes, namely Short wide noodles with a 90-degrees twist; Ricciutelle-like shapes, namely Short spiralled noodles; Rotelle-like shapes, namelyWagon wheel-shaped product; Rotini-like shapes, namely 2-edged spiral, tightly wound, some vendors and brands are 3-edged and sold as rotini; Sorprese-like shapes, namely Bell shaped product with a crease on one side and has a ruffled edge; Sorprese Lisce-like shapes, namely Bell shaped product with a crease on one side and has a ruffled edge (A larger version of Sorprese); Strozzapreti-like shapes, namely Rolled across their width; Torchio-like shapes, namelyTorch shaped; Trofie-like shapes, namely Thin twisted product; Acini di pepe-like shapes; Alfabeto-like shapes, namely product shaped as letters of the alphabet; Anellini-like shapes, namely Smaller version of anelli Little rings; Couscous-like shapes, namely Grain-like product; Conchigliette-like shapes, namely Small shell-shaped product; Corallini-like shapes, namelySmall short tubes of product; Ditali-like shapes, namely Small short tubes; Ditalini-like shapes, namely Smaller versions of ditali; Farfalline-like shapes, namely Small bow tie-shaped product; Funghini-like shapes, namely Small mushroom-shaped product; Grattini-like shapes, namely Small granular, irregular shaped product (smaller version then Grattoni; Grattoni-like shapes, namely Large granular, irregular shaped product; Midolline-like shapes, namely Flat teardrop shaped product (similar to Orzo but wider); Occhi di pernice-like shapes, namely Very small rings of product; Orzo (also, risoni)-like shapes, namelyRice shaped product; Pastina-like shapes, namely Small spheres about the same size or smaller than acini di pepe; Pearl Pasta-like shapes, namelySpheres slightly larger than acini di pepe; Quadrettini-like shapes, namely Small flat squares of product; Stelline-like shapes, namely Smaller version of stele; Stortini-like shapes, namely Smaller version of elbow macaroni; Agnolotti-like shapes, namely Semicircular pockets; Cannelloni-like shapes, namely Rolls of product with various fillings, usually cooked in an oven; Cappelletti-like shapes, namely Square of dough, filled with minced meat, and closed to form a triangle Little caps; Casoncelli or casonsèi-like shapes, namely A stuffed product typical of Lombardy, with various fillings; Casunziei-like shapes, namely A stuffed product typical of the Veneto area, with various fillings; Fagottini-like shapes, namely A ‘purse’ or bundle of product; Maultasche-like shapes, namely a product stuffed with meat and spinach; Mezzelune-like shapes, namely Semicircular pockets; about 2.5 in. diameter-Half-moons; Occhi di lupo-like shapes, namely A large, penne-shaped product that is stuffed Ribbed wolf eyes; Pelmeni-like shapes, namely Russian dumplings; Sacchettoni-like shapes, namely Large little sacks; Tortellini-like shapes, namely Ring-shaped, stuffed with a mixture of meat and cheese; Tortelloni-like shapes, namely Round or rectangular, similar to ravioli, and any mixture or combination or derivative thereof.

The fresh plant is either in its fresh form with 96% internal moisture or in a dissipated or dried form that can be hydrated by adding water.

General recipe for making fresh or wet pasta:

50% (w/w) flour+50% (w/w) water+1% salt (no yeast).

In the first step, mixing is done until the ingredients unite and uniform but the dough does not open, meaning that no gluten network starts to develop.

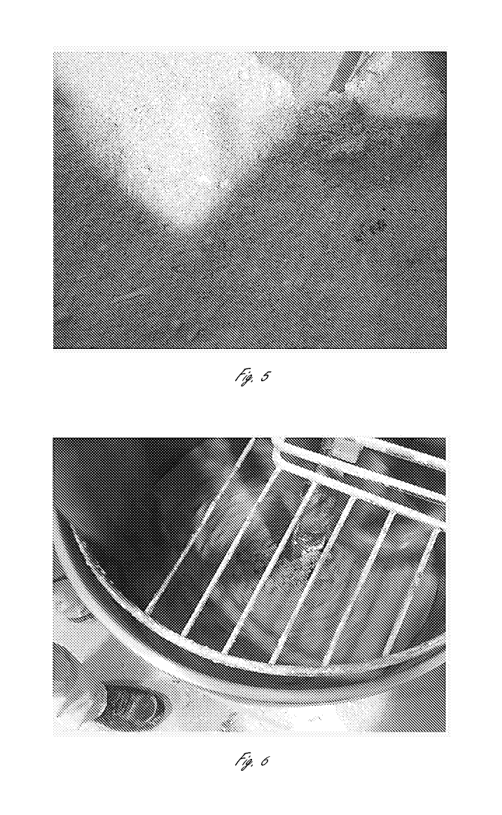

Reference is now made to FIG. 5 presenting a photo showing the beginning of the step of uniting the ingredients for preparing wet pasta. The figure shows the main two ingredients of the wet pasta dough which are flour and plant material (duckweed).

Reference is now made to FIG. 6 which is a photo showing the beginning of the kneading process in which the flour starts to unite with the plant material.

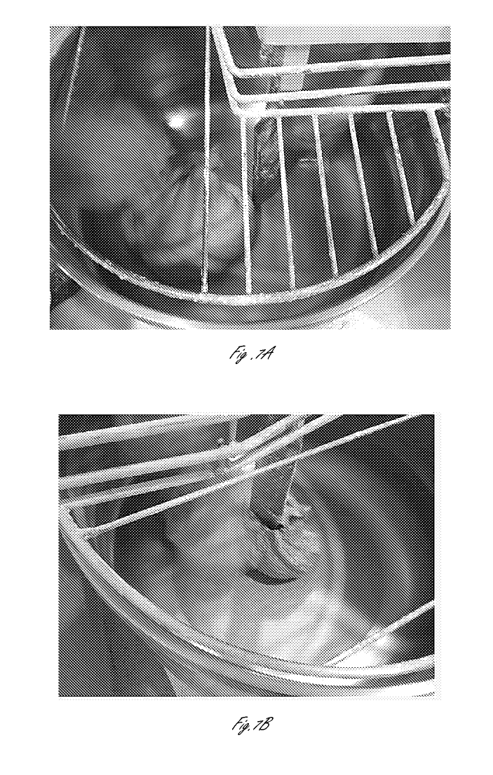

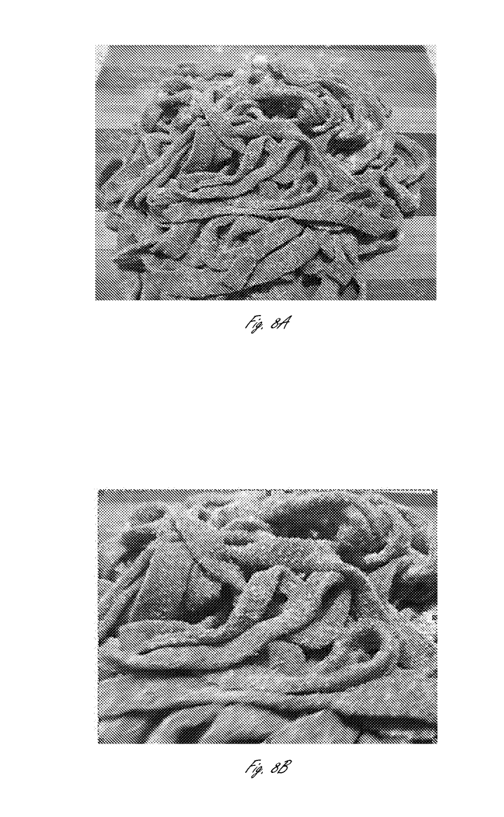

Reference is now made to FIGS. 7A and 7B which show a photo of the kneading process of the wet pasta dough. FIG. 7B shows the point when the forming of the gluten network begins and kneading must be stopped so the network will not keep forming to give an unstable pasta dough that cannot hold a shape.

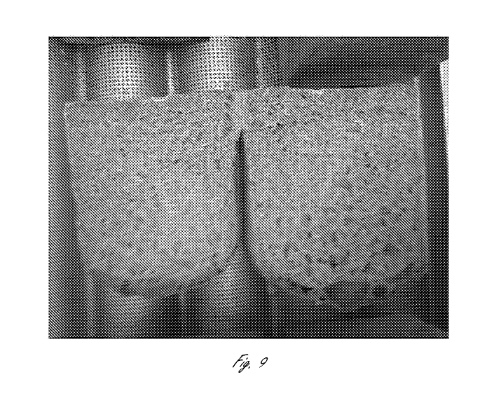

Reference is now made to FIGS. 8A and 8B which are photos of wet pasta made with duckweed.

In bread dough, after the ingredients unite there is a need for the dough to develop a gluten network. Hydrogen bonds expand with water absorption. The yeast cut the bonds which cause the protein to close and look like a yarn ball. Kneading opens the protein and enables future water release in the oven as a result of the heat while still preserving the structure of the dough having bubbles.

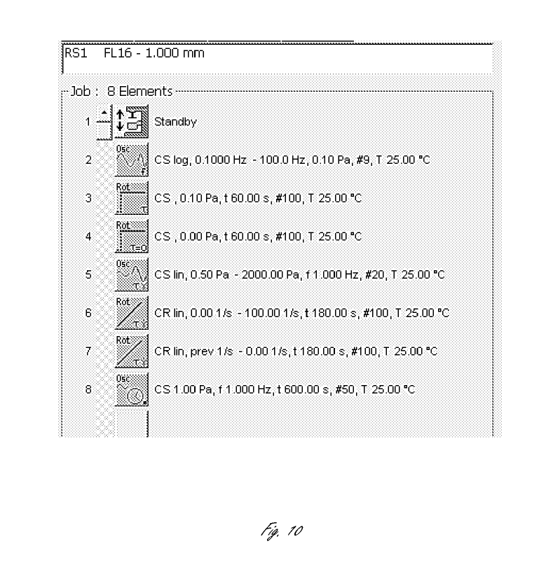

Reference is now made to FIG. 9 which is a photo of bread made from dough containing 70% to 80% fresh whole duckweed. The difference from the pasta dough is clear. The main cause is that in the pasta dough a gluten network was not formed while in the bread dough a very developed network is formed.

In fresh pasta dough one should be careful not to proceed to the opening stage after uniting the ingredients. If crossing this stage the dough is designated to cook. While cooking it swells a little bit and its specific gravity changes and it floats on water. If such a process does happen (swelling) the dough will lose its holding ability and disintegrate.

The test: after forming the dough if after pressing on the dough it returns to its original shape—this means forming a gluten network has ensued.

In pasta dough a hard dough should be formed according to the accepted measurements. Measured by a tensometer. The tensometer checks the stretching ability of the dough in different levels of protein bond opening and expansion of the 3 dimensional gluten network (in the case of forming a gluten network).

a. 50% flour+50% wet plant with 96% internal moisture+1% salt.

b. Mix until the stage of uniting the ingredients and then additional mixing until reaching the step of dough formation. Use an inverse kneading machine to prevent opening of the dough (formation of gluten network).

c. Short mixing time relatively to the dough. 75% of time. More details will be given.

d. Kneading method: inside, not outside, press inside, do not stretch outside—an explanation will be given.

Uniform color, texture, color strength, according to the amount of the amount of plant solids.

In any case, the dough is characterized by turning the plant to an integral part of it just by being wet. It is possible to increase the amount of plant solids by evaporating part of the plant's water to a level of 30% internal moist which is still sufficient for kneading. In any case, the amount of water cannot be changed.

Explanation: 50% flour+50% plant (96% moist)+1% salt (weight).

When relating to 50% plant the meaning is the amount of liquid within it.

For example: 1 kg flour+1 lg moist plant, 4% solids, 8% solids, 12% solids—the exact data will be given. Maximum percentage of solids. No overloading on the stretching ability of the pasta.

### Example 5

This example demonstrates further embodiments of the present invention comprising:
a) preparation of 12 samples of dough
b) rheological characterization of the 12 samples of dough.

The chemical compositions of the 12 dough samples are presented in Table 8 and Table 9.

TABLE 8
Dough with Flour and Water

| | | Flour | | water | salt | yeast |
|---|---|---|---|---|---|---|
| | Mass of dough | Type | mass | mass | mass | mass |
| Samples | [g] | [g] | [g] | [g] | [g] | [g] |
| S1A | 1000 | wheat | 650.0 | 350.0 | 0 | 0 |
| S2A | 1000 | wheat | 650.0 | 350.0 | 15.0 | 16.0 |
| S3A | 1000 | rye | 575.7 | 424.3 | 14.4 | 23.1 |
| S4A | 1000 | wheat | 600.0 | 400.0 | 15.0 | 16.0 |
| S5A | 1000 | wheat | 650.0 | 350.0 | 15.0 | 8.0 |
| S6A | 1000 | wheat | 613.5 | 386.5 | 12.5 | 25.1 |

TABLE 11
Dough with Flour and Plant without Water

| | | Flour | | Plant | salt | yeast |
|---|---|---|---|---|---|---|
| | Mass of dough | Type | mass | mass | mass | mass |
| Samples | [g] | [g] | [g] | [g] | [g] | [g] |
| S1B | 1000 | wheat | 631.6 | 368.4 | 0 | 0 |
| S2B | 1000 | wheat | 631.6 | 368.4 | 15.0 | 16.0 |
| S3B | 1000 | rye | 575.7 | 424.3 | 14.4 | 23.1 |
| S4B | 1000 | wheat | 579.0 | 421.0 | 15.0 | 16.0 |
| S5B | 1000 | wheat | 631.6 | 368.4 | 15.0 | 8.0 |
| S6B | 1000 | wheat | 613.5 | 386.5 | 12.5 | 23.1 |

All samples have been prepared using the mixer “MECNOSUB” model IMBD. However any conventional mixer designed for this procedure can be used.

It is noted that the sample series S1B to S6B were designed to contain the same ingredients as sample series S1A to S6A, except for the plant material. It should be further noted that the dough sample series S1B to S6B are designed to have the same solid component to liquid component ratio as sample series S1A to S6A, while the solid component of the dough comprises flour or flour and dry plant material, and the liquid component of the dough comprises water or solution extracted from the aquatic plant material by cell disruption processes during the kneading of flour and fresh plant.

It is further within the scope that the same results may be obtained with samples containing flour and liquid essentially derived from fresh whole Wolfia plant, meaning that an insignificant amount of water (i.e. up to about 20% of the liquid component required to form the dough) is added in addition to flour and fresh plant.

The processing parameters for samples A and B [1; 2; 3; 4; 5; 6] are:
Mass of dough (flour and water or flour and fresh plant with humidity of 95%) is constant at a value of 1000 grams;
All compounds have been weighted before mixing;
Mixing has been done in two phases: 5 minutes at speed 1 and 4 minutes at speed 2 of the mixer;
Total time of preparation has been about 50 minutes at 25° C.

The dough of samples S3A and S3B have been mixed only in a single phase during 10 minutes, which represented the total time of sample preparation. All 12 samples of dough have been let to rest for rising at room temperature of 25° C. after preparation.

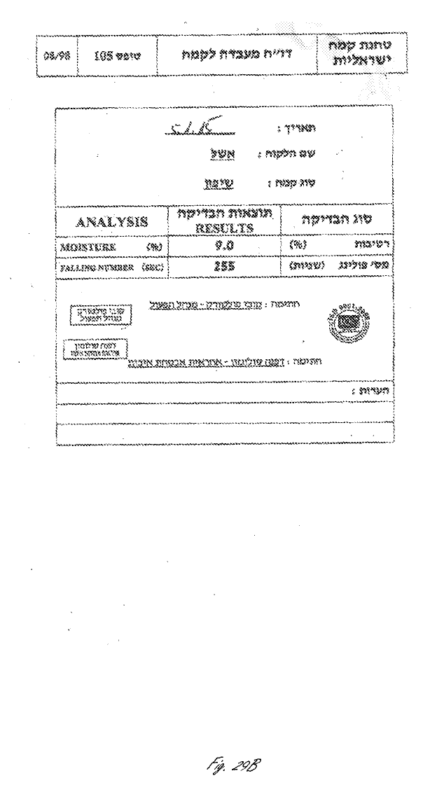

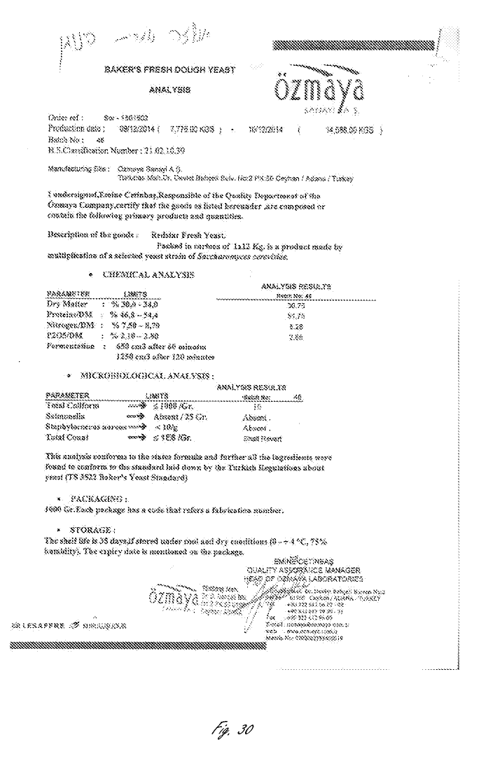

The technical characteristics of the two types of flour used (wheat and rye) are presented in Table 10. More characteristics are presented in FIG. 29A (wheat flour) and FIG. 29B (rye flour).

TABLE 10
Characteristics of wheat and rye flour

| Flour type | Analyze type | Result |
|---|---|---|
| Wheat | Moisture (%) | 13.97 |
| | Falling Number (sec) | 387 |
| Rye | Moisture (%) | 9 |
| | Falling Number (sec) | 255 |

The rheological characterization of the samples has been done with rheometer “ThermoHaake RheoStress 1” used as an exemplary of a conventional rheometer.

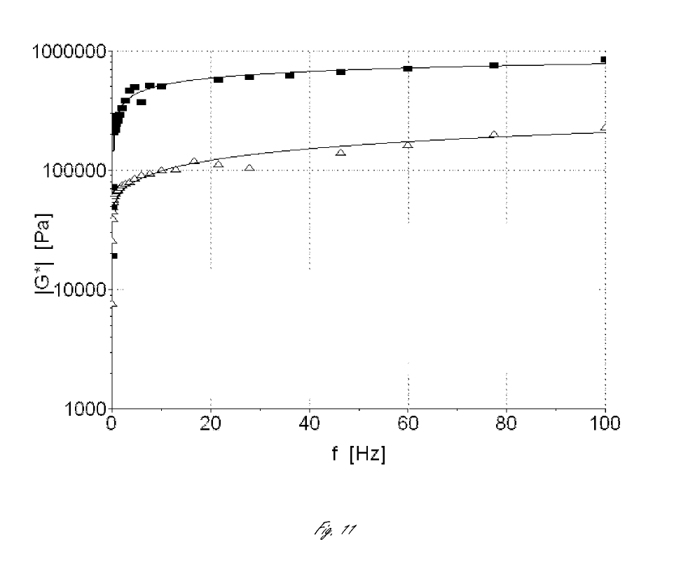

The rheological characterization of the 12 samples of dough (S1A to S6A, and S1B to S6b) has been done with a solicitation program presented in FIG. 10.

Reference is now made to FIG. 10 presenting a solicitation program of total execution time of 40 minutes, with 5 minutes interval between two elements of solicitation. The sensor used in this program is FL16 with star shape geometry.

For some types of solicitations, programs have been carried out adapted to specific material entity which corresponds to samples that does not respond properly to the implementation of the general program of solicitation adopted.

The meaning of the solicitation elements presented in FIG. 10 (referring to the general program of solicitation) is mentioned below:

(2) Oscillation Frequency Sweep—The Frequency Sweep can describe unusual flow behavior. The shapes of the material function curves reveal structural characteristics of the sample;

(3+4) Evaluation of the Creep/Recovery analysis—Determination of relevant quantities based on creep and recovery curve:

(a) Zero shear viscosity (or Newtonian viscosity): ηo

(b) Elastic deformation: γeo

(c) Equilibrium shear compliance: Jeo=γεo/τo

(d) First normal stress coefficient: Ψ10=2ηo2 Jeo

(e) Characteristic relaxations time: λo=ηo Jeo

(f) Transient elastic behavior: ‘Creep minus Flow’

The following equation describes the Creep/Recovery analysis:

$${γ}_{e} ( t ) = ( γ ( t ) - \frac{{τ}_{o}}{{η}_{o}} )$$

(5) The Oscillation Stress Sweep—is used to determine the material's linear visco-elastic range, which is to demonstrate that the measurement parameters are set in a manner that the stress and strain amplitude have a linear relationship. According to one aspect, the critical point of the stress sweep is reached at the maximum deformation.

(6+7) Thixotropy Test, also known as Thixotropic Loop, is a test procedure that determines time effect related flow properties. When ramping up the material it is exposed to shear forces, which will destroy its internal structure. This gives reason for a shear-thinning behavior also observed when running a viscosity curve.

(8) Oscillation Time Sweep—Oscillation Time Sweep is the ideal tool to observe how material changes over time.

In an oscillation experiment the material is subjected to a sinusoidal stress applied to it. It is designed to be a non-destructive test.

By incorporating this type of method we get access to the characterization of materials which cannot be sheared due to their three dimensional structure (e.g. gels) or due to their elastic properties (material won't stay in the measuring gap).

Furthermore oscillation tests can be helpful to differentiate between two samples which cannot be distinguished by shear experiments. That is because the oscillation test is capable to separate elastic and viscous properties, while shearing leads to an integrated characterization only.

For the evaluation of an oscillation experiment the following basic equation is used:

τo=G*γo

G* represents the complex modulus. By setting the stress amplitude and measuring the deformation amplitude this modulus can be calculated.

By knowing the frequency and measuring the time at which stress and strain (deformation) amplitudes are reached, the phase shift between both amplitudes can be calculated, which is then used to determine the storage and loss modulus.

The storage modulus G′ is a representative of the elastic properties of a material:

G′=G*·cos δ

For a purely elastic material the phase shift is zero what makes cos δ to equal 1. Thus, G′ 100% reflects the integral character G*.

The loss modulus G″ is a representative of the viscous properties of a material:

G″=G*·sin δ

For a purely viscous material the phase shift is 90° what makes sin δ to equal 1. Thus, G″ 100% reflects the integral character G*.

One might be interested in the ratio of viscous and elastic properties. This is commonly calculated by the following equation:

$$\frac{{G}^{″}}{{G}^{′}} = \frac{sin δ}{cos δ} = tan δ$$

According to a further embodiment, a viscosity value may be obtained from an oscillation experiment. The complex dynamic viscosity η* is derived from the following equation:

$${η}^{*} = \frac{{G}^{*}}{ω}$$

The obtained results concerning the rheological characterization are presented in Table 11 and in FIG. 11 to FIG. 24.

TABLE 11
Rheometric characteristics of the dough samples

| | Rheometric characterization | | | | | |
|---|---|---|---|---|---|---|
| | Oscillation | | Oscillation | | Creep | Oscillation |
| | Frequency Sweep | | Stress Sweep | | Analysis | Time Sweep |
| Dough | G* | Tan(δ) = G″/G′ | [G″ = G′]cr | [τ]cr | m-properties | G*(t) |
| Samples | [Pa] | [—] | [Pa] | [Pa] | ηo | [Pa] |
| S1-A | 56,680.00 | 0.45 | 12,500.00 | 895.00 | 28,100.00 | 51,330.00 |
| S1-B | 259,000.00 | 0.50 | >25000 | >2000 | 7,690.00 | 95,280.00 |
| S2-A | 72,930.00 | 0.30 | n/a | 351.00 | N/A | N/A |
| S2-B | 150,300.00 | 0.83 | n/a | 463.20 | N/A | N/A |
| S3-A | 111,000.00 | 0.45 | n/a | n/a | N/A | N/A |
| S3-B | 109,100.00 | 0.41 | n/a | n/a | N/A | N/A |
| S4-A | 16,580.00 | 0.42 | 2,131.00 | 422.00 | N/A | N/A |
| S4-B | 26,560.00 | 0.45 | 4,408.00 | 1,156.00 | N/A | N/A |
| S5-A | 56,440.00 | 0.30 | n/a | N/A | N/A | N/A |
| S5-B | 110,000.00 | 0.75 | n/a | N/A | N/A | N/A |
| S6-A | 18,550.00 | 0.48 | 2,787.00 | N/A | N/A | N/A |
| S6-B | 27,930.00 | 0.53 | 3,458.00 | N/A | N/A | N/A |

It is noted that N/A in Table 11 means that the respective solicitations haven't been done or that the numerical values in the range of solicitation parameters adopted in conformity with the program mentioned in FIG. 10were not generated.

The presented FIGS. 11-24 contain additional information complementing Table 11.

Reference is now made to FIG. 11 graphically illustrating the influence of oscillation frequency on the complex elastic modulus G* for samples S1A and S1B.

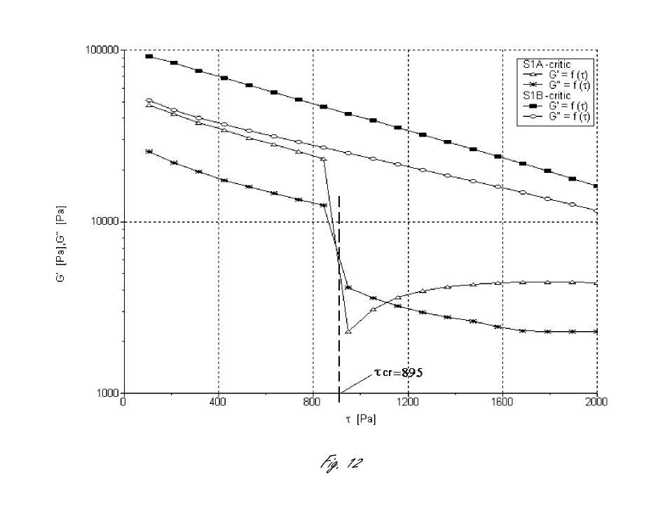

Reference is now made to FIG. 12 graphically illustrating solicitations of samples S1A and S1B with the element Oscillation Stress Sweep which show the critical tension τ_{cr} present at sample S1A (which is dough without plant), not present in sample S1B.

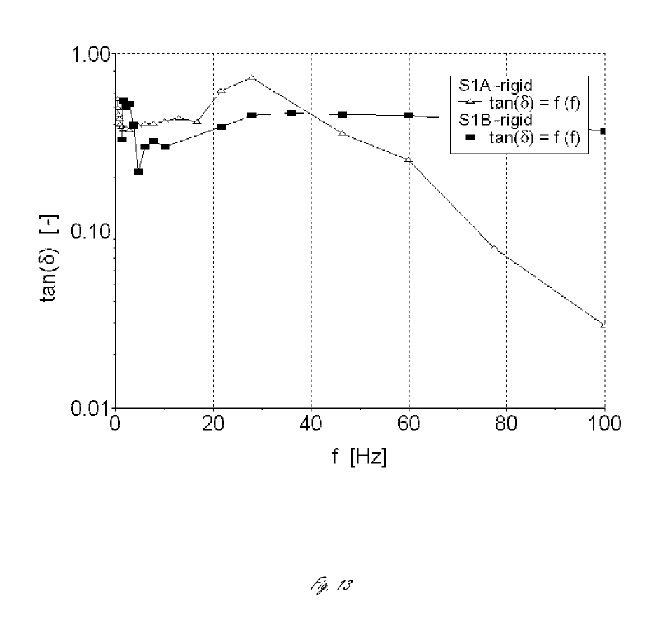

Reference is now made to FIG. 13 graphically illustrating variation in tan δ values between samples S1A and S1B upon solicitation with element Oscillation Frequency Sweep. It can be seen that sample S1B which contains plant, represents a viscoelastic material entity with elastic character more accentuated than the material entity of sample S1A, which does not contain any plant material.

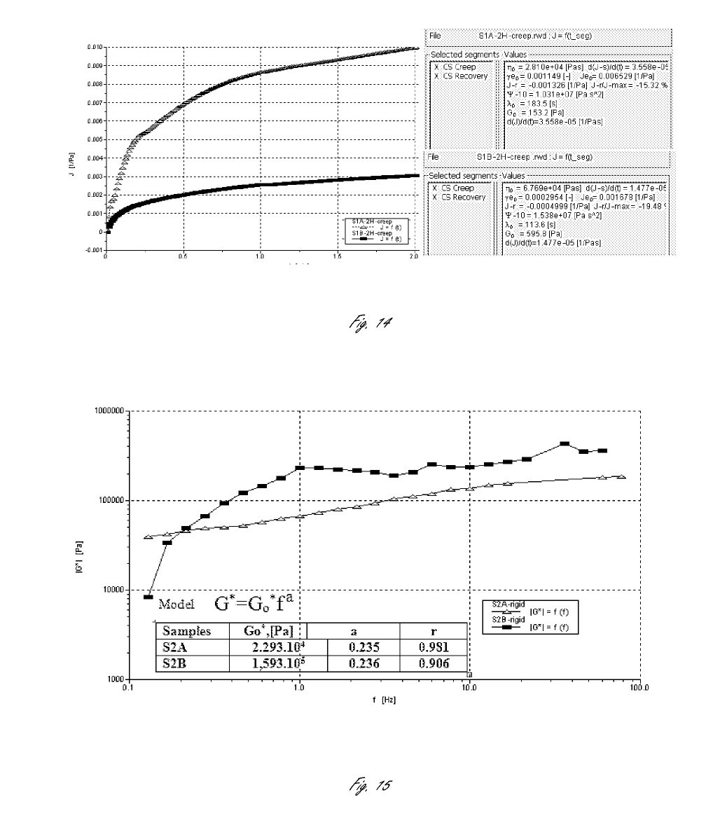

Reference is now made to FIG. 14 graphically illustrating the influence of solicitation's time on the compliance of S1A and S1B as dough. In this embodiment, the results of the Creep Analysis of samples S1A and S1B which has been let to rest 2 hours for stabilization after processing for eliminating the deformation generated by preparation, are shown. It is observed from the results that the dough which contains plant (S1B) has a lower capacity of deformation than the sample S1A, which is deprived of plant material.

Reference is now made to FIG. 15 graphically illustrating the influence of solicitation frequency on complex elastic modulus G* for samples S2A and S2B.

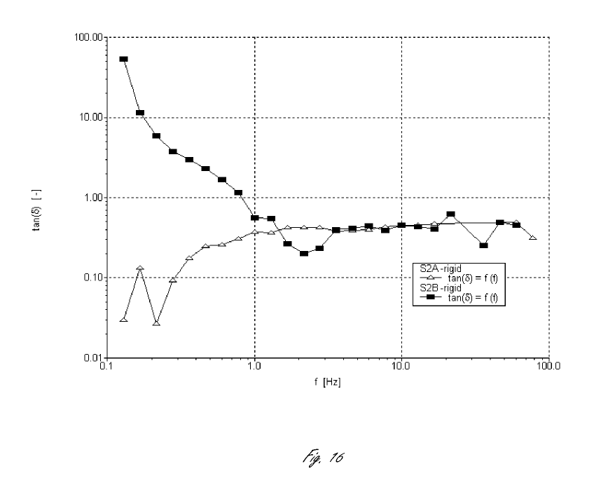

Reference is now made to FIG. 16 graphically illustrating the influence of solicitation frequency on rheological tan(δ) values of samples S2A and S2B. It is remarked that the dough with plant and yeast (S2B) represents a viscoelastic material entity with plastic compound higher than the sample S2A which contain the same quantity of yeast as S2B, but is deprived of plant material. It is noted that the combination of yeast and plant allows generating a bigger porosity and this explains the superior speed of rising in experiments of rising dough with plant.

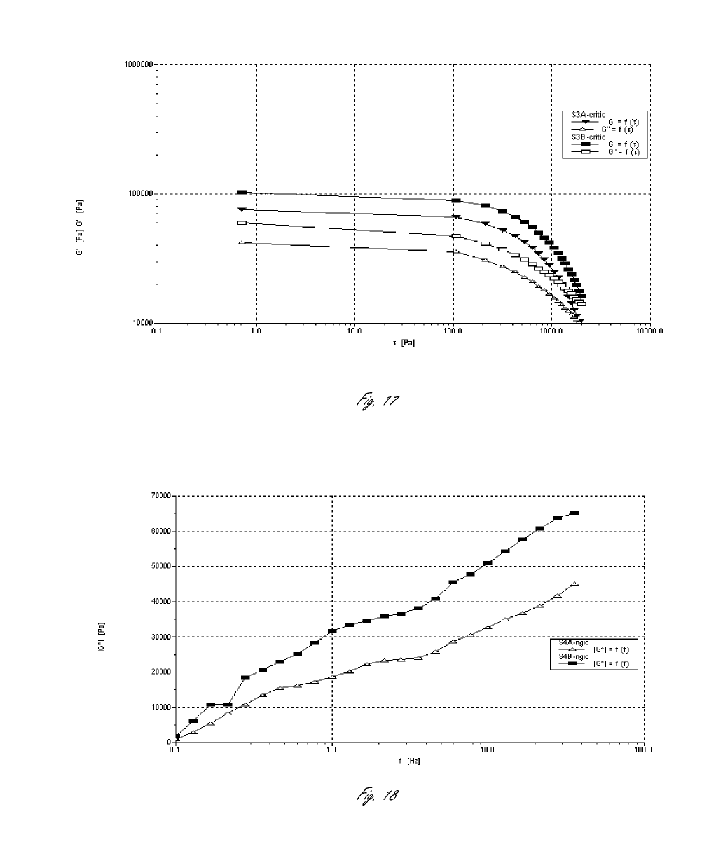

Reference is now made to FIG. 17 graphically illustrating the influence of solicitation tension with element Oscillation Frequency Sweep for samples S3A and S3B. It can be seen from this figure that when using the rye flour, it generates more intense interactions with the plant than in the case of using the wheat flour, resulting is a critical tension higher than 2000 Pa.

Reference is now made to FIG. 18 graphically illustrating the influence of solicitation frequency on complex elastic modulus G* for samples S4A and S4B.

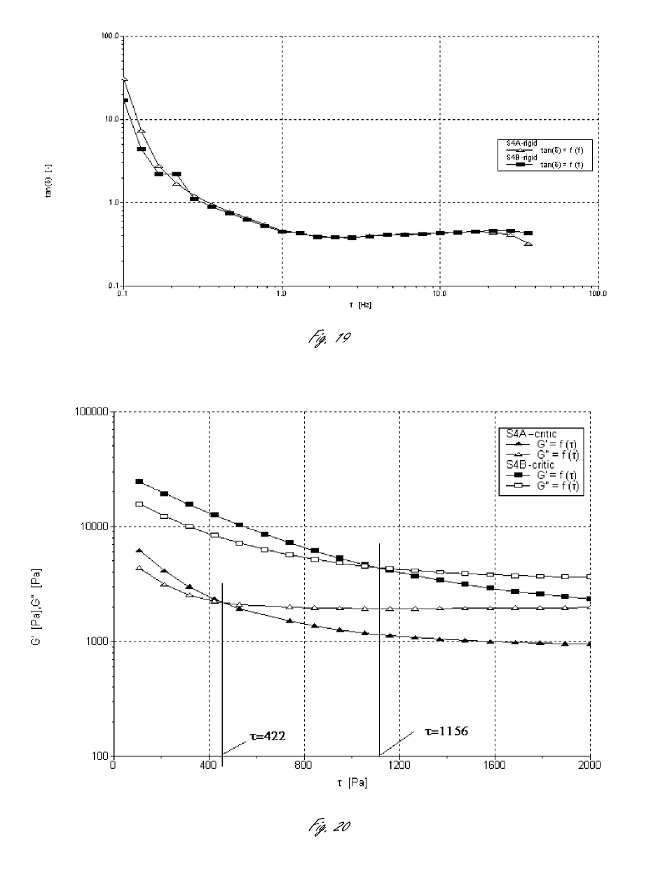

Reference is now made to FIG. 19 graphically illustrating the influence of solicitation frequency on rheological property tan(δ) for samples S4A and S4B.

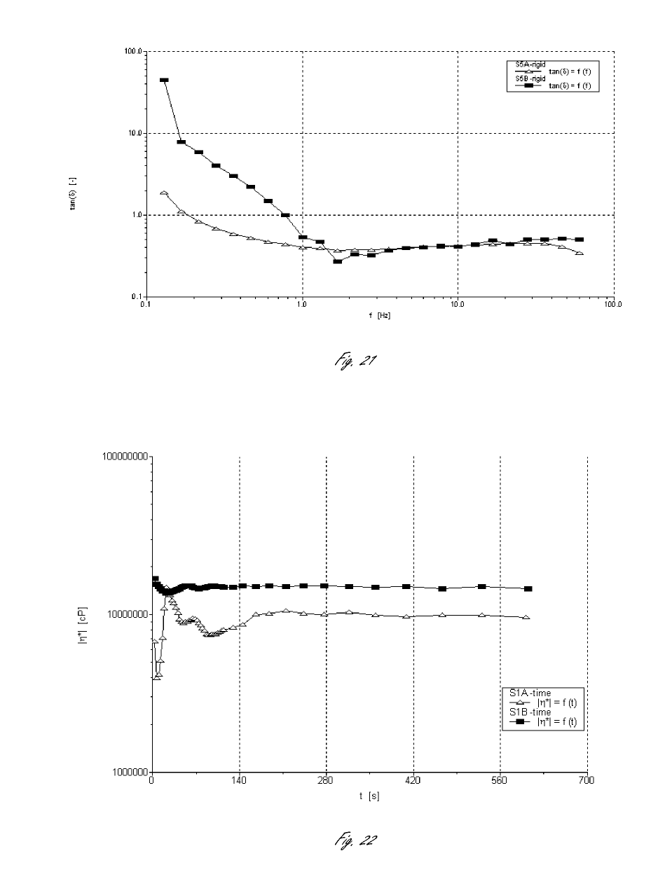

Reference is now made to FIG. 20 graphically illustrating the influence of solicitation tension with element Oscillation Frequency Sweep for samples S4A and S4B. This figure demonstrates that the critical tension τ_{cr} present in sample S4A (dough without plant) is at solicitation tension of (τ_{cr}=422 Pa), which is significantly lower than the critical tension τ_{cr} of sample S4B containing the plant. The dough with the plant material (S4B) has a much higher solicitation tension of (τ_{cr}=1156 Pa).

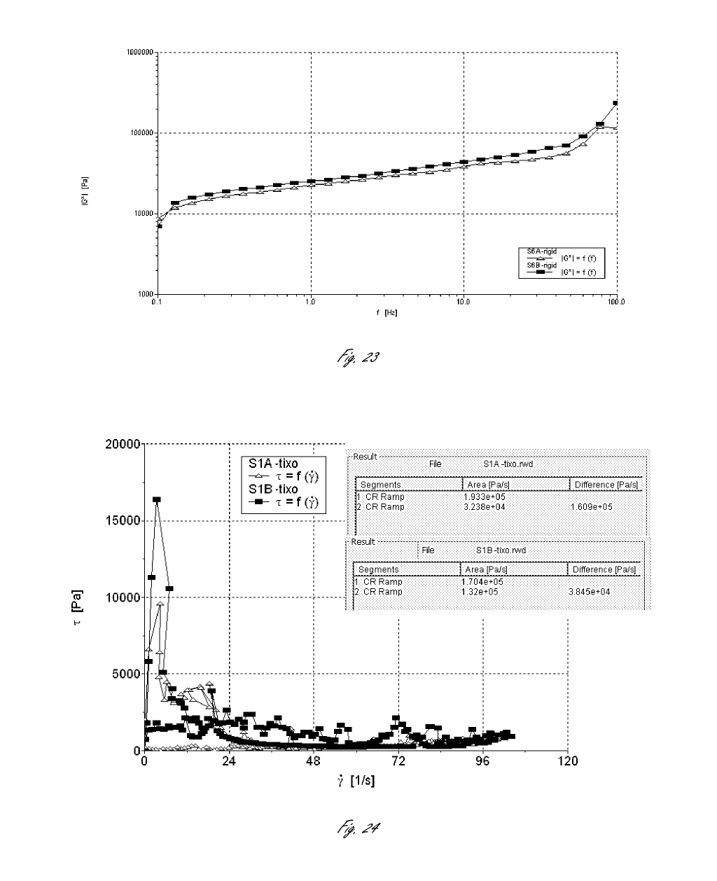

Reference is now made to FIG. 21 graphically illustrating the influence of solicitation's frequency on rheological property tan(δ) of samples S5A and S5B. It is remarked that the dough containing plant and yeast represents a viscoelastic material entity with a plastic compound higher than the sample S5A that contain the same quantity of yeast as S5B but is deprived of plant material.

Reference is now made to FIG. 22 graphically illustrating the influence of solicitation's time on complex viscosity η* with element Oscillation Time Sweep after 60 minutes from the preparation starting point of dough samples S1A and S1B. It can be seen that the dough containing plant material has a higher consistency and is more stable than the dough sample S1A without the plant.

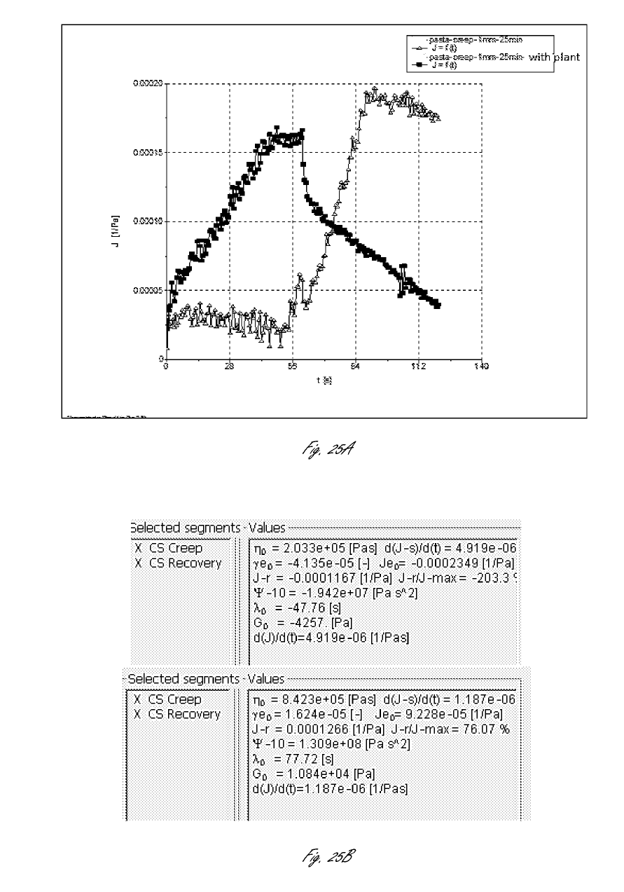

Reference is now made to FIG. 23 graphically illustrating the influence of solicitation's frequency on complex elastic modulus G* for samples S6A and S6B.

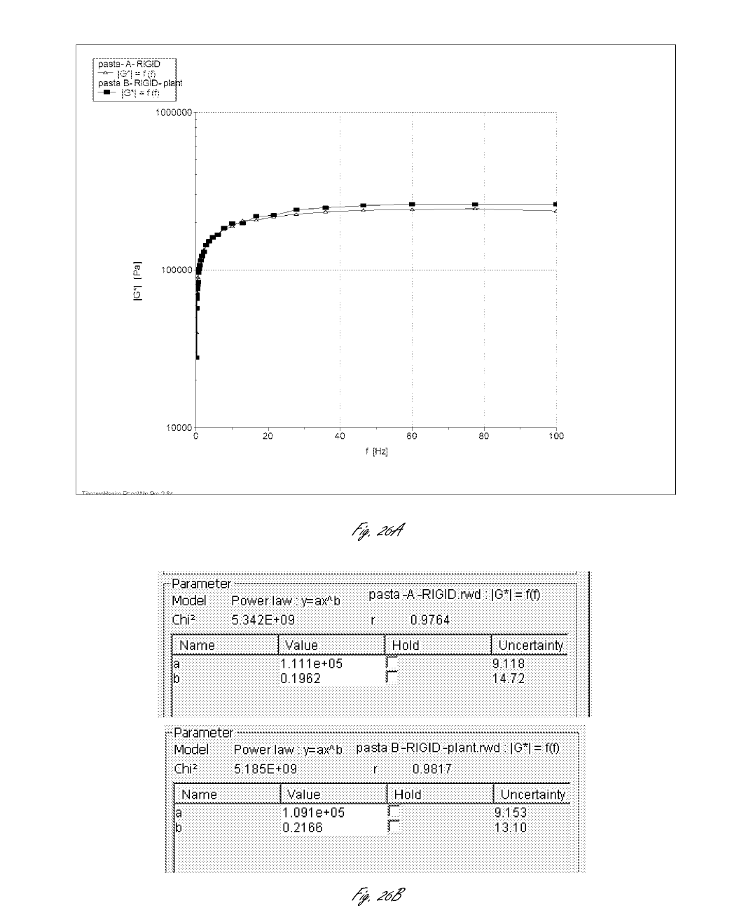

Reference is now made to FIG. 24 graphically illustrating the behavior of samples S1A and S1B at solicitation with shear rate in the range of 0 to about 100 s⁻¹, when the Thixotropic Loop element is examined It can be seen that the dough containing plant material is less thixotropic (the difference in the surface under the curve is 38,450 Pas for sample S1B versus 160,900 Pas for sample S1A.

From the data described above, the following conclusions concerning the rheological characterization of the 12 samples of dough detailed above could be drawn:

a) The use of the aquatic plant (Wolffia) as water source for the dough preparation generates material entities (S1B to S6B sample series) more rigid than the dough samples made with water only, without plant, but with the same ratios between the solid component (flower and dry plant material) and liquid component (water and liquid or solution extracted from the plant).

b) The dough samples which contain the plant material (S1B to S6B sample series) are more stable to mechanical solicitations, i.e. the values of τ_{critic} are higher than the dough samples having the same ratios between the dry and liquid components of the dough but are deprived of plant material (S1A to S6A sample series);

c) There are differences in the rheological properties between the two types of dough (without plant [A] and with the plant [B]) caused by the specific formulations which are influenced by the following factors: flour type; amount of water; ratio of flour:plant; processing parameters; concentration of salt and concentration of yeast.

d) It was observed that when the dough is prepared using only flour and fresh aquatic plant the flour interacts more intensively with the solution released from the plant comparative with the weaker interactions resulted when the dough is prepared using only flour and water.

e) It is further noted that the rheological data described in Table 11 confirm the data provided by farinograph and described in FIGS. 10-24.

### Example 6

In this example, dough samples with and without the Wolffia fresh plant, for pasta preparation, are examined. The chemical compositions of 2 dough samples for pasta are given in Table 12.

TABLE 12
Dough samples for pasta with and without the aquatic plant

| | Flour | | water | salt | plant |
|---|---|---|---|---|---|
| | Type | mass | mass | mass | mass |
| Samples | [g] | [g] | [g] | [g] | [g] |
| A | wheat | 1000 | 600 | 20 | 0 |
| B | wheat | 1000 | 0 | 20 | 631 |

The processing parameters for samples A and B are:

### Sample A

Measuring the weight of each of the components;
Mixing the amount of wheat flour with the amount of water for 3 minutes at speed 1; and adding the amount of salt and continuing the mixing at speed 2 for additional 4 minutes.

### Sample B

Measuring the weight of each of the components;
Mixing the amount of wheat flour with the amount of plant for 12 minutes at speed 1; and adding the amount of salt and continuing the mixing at speed 2 for additional 4 minutes.

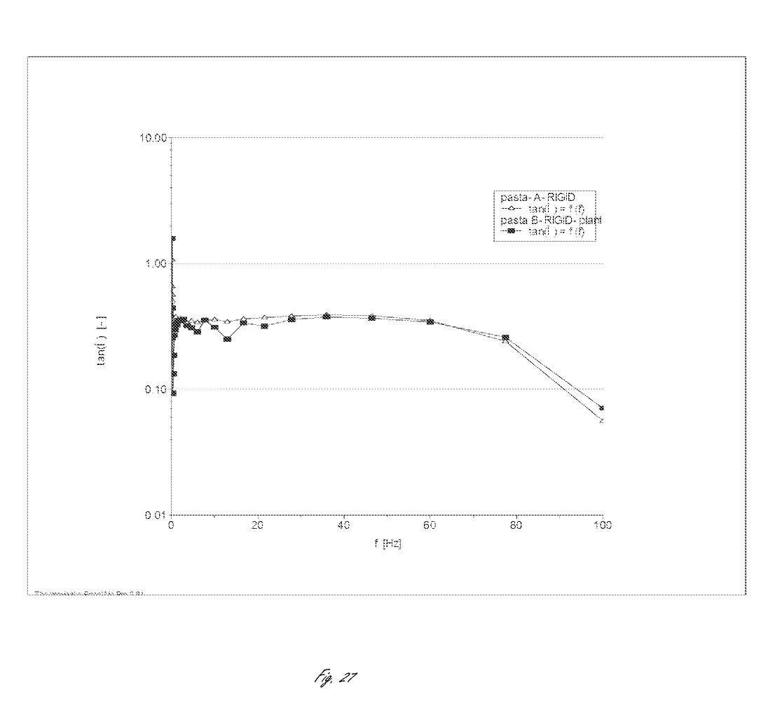

The rheology results for the pasta dough samples are shown in FIGS. 25-28.

Reference is now made to FIG. 25A graphically illustrating creep analysis of pasta dough A (prepared with water) and pasta dough B (prepared with the Wolffia plant)

Reference is now made to FIG. 25B presenting pasta dough parameters; particularly creep analysis data (1 mm, 25 min) of dough without plant material and dough prepared with plant material, having the same solid or total dry material to liquid component ratio.

The term creep refers to the tendency of a solid material to move slowly or deform permanently under the influence of mechanical stresses.

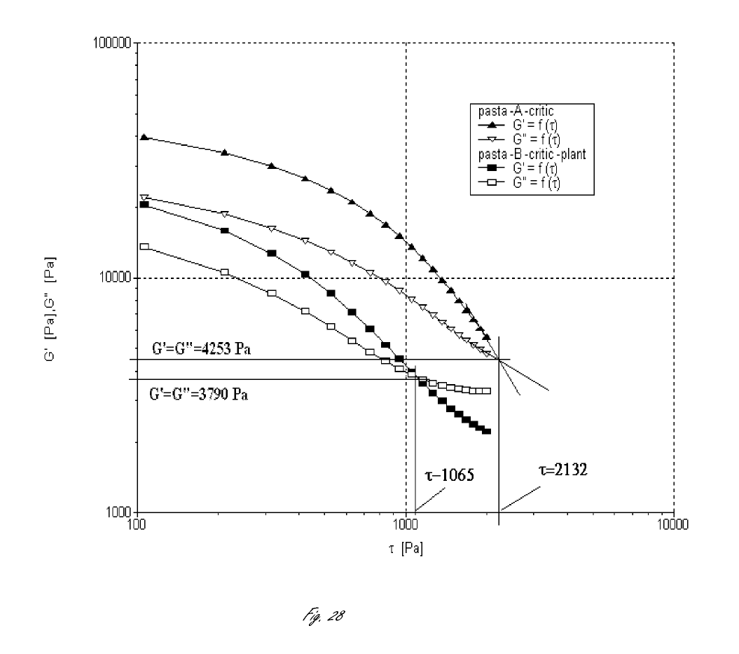

Reference is now made to FIG. 26A graphically illustrating the influence of oscillation frequency on the complex elastic modulus G* for samples A and B. Rigidity evaluation of pasta dough samples A and B is shown in FIG. 26B. It can be concluded from this figure that dough sample B, prepared with the aquatic plant as the source for liquid in the dough, has similar rigidity as conventional dough prepared with water and flour (sample A).

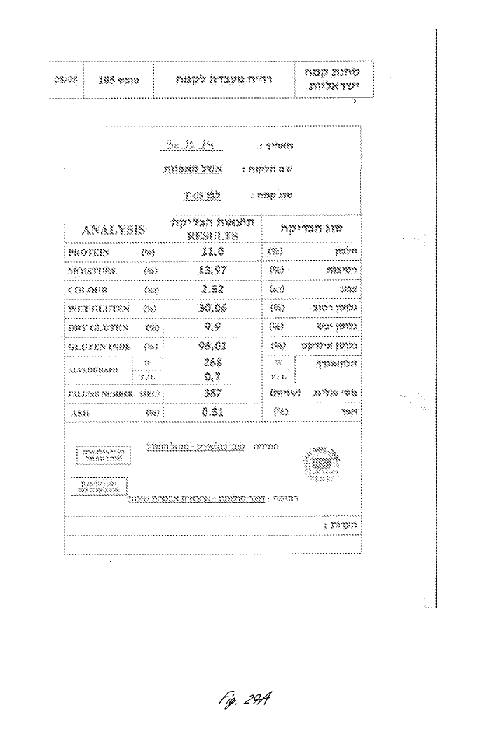

Reference is now made to FIG. 27 graphically illustrating the influence of solicitation frequency on rheological property tan(δ) for samples A and B.

Reference is now made to FIG. 28 graphically illustrating the influence of solicitation tension evaluated by Oscillation Frequency Sweep for samples A and B. It can be seen that the pasta dough prepared with four and water (A) has a higher, by about twice, critical tension τ_{cr} present in sample S4A (dough without plant) is at solicitation tension of (τ_{cr}=422 Pa), which is significantly lower than the critical tension τ_{cr} of sample S4B containing the plant. The dough with the plant material (S4B) has a much higher solicitation tension of (τ_{cr}=1156 Pa).

The results described in this example demonstrate the unique rheological characteristics of the novel pasta dough made of flour and fresh plant of the present invention.

1.-72. (canceled)

73. A malleable mass of dough comprising:
a. dry material; said dry material comprises flour; and,
b. a liquid component; wherein said liquid component comprising liquid essentially originating from fresh whole Wolffia genus plant added to said dry material during the kneading process; said liquid component extractable from said fresh whole plant during the plant disruptive dough kneading process; post kneaded ratio of said whole fresh plant to disrupted plant is at least 50% lower than a corresponding dough comprising same ratio of dry material to liquid component defined as water, said corresponding dough is further characterized by: (i) Wolffia added post kneading, or (ii) Wolffia added after characteristics of dough have been substantially attained, or (iii) Wolffia added in addition to the liquid component of said dough, or any combination thereof.

74. The dough of claim 73, wherein at least one of the following holds true:
a. no more than 20% of the total amount of said liquid component, is externally added water;
b. at least 80% of said liquid component comprises liquid originating from said fresh whole Wolffia;
c. about 100% of said liquid component comprises liquid originating from said fresh whole Wolffia.

75. The dough of claim 73, wherein said Wolffia plant is selected from the group consisting of Wolffia angusta, Wolffia arrhiza, Wolffia australiana, Wolffia borealis, Wolffia brasiliensis, Wolffia columbiana, Wolffia cylindracea, Wolffia elongata, Wolffia globosa, Wolffia microscopica, and Wolffia neglecta.

76. The dough of claim 73, wherein said flour is selected from the group consisting of wheat flour, whole flour, buckwheat flour (gluten free), durum wheat, rice flour, rye flour, oat flour, corn flour, teff flour, and combinations thereof.

77. The dough of claim 73, wherein said whole fresh plant is selected from the group consisting of whole plant, essentially intact plant, whole cells and any combination thereof.

78. The dough of claim 73, wherein said disrupted plant is selected from the group consisting of pieces of the plant, plant part, cell debris, fractionated plant cells, shriveled fronds, a powder of the whole plant, juice plant, partially dried plant, essentially fully dried plant, processed plant and any combination thereof.

79. The dough of claim 78, wherein said juice plant comprises suspension from said fresh plant cells with a solid content of between about 1% and about 15%.

80. The dough of claim 73, wherein said dough has characteristic rheological properties relative to a corresponding dough having similar liquid to total dry material ratio, said corresponding dough being absent of said Wolffia plant.

81. The dough of claim 73, wherein said dough has at least one characteristic selected from the group consisting of:
a. higher rigidity relative to a corresponding dough having similar liquid to total dry material ratio, said corresponding dough being absent of said Wolffia plant;
b. higher stability to mechanical solicitations relative to a corresponding dough having similar liquid to total dry material ratio, said corresponding dough being absent of said Wolffia plant;
c. higher τ_{critic} value relative to a corresponding dough having similar liquid to total dry material ratio, said corresponding dough being absent of said Wolffia plant;
d. a lower deformation capacity relative to a corresponding dough having similar liquid to total dry material ratio, said corresponding dough being absent of said Wolffia plant;
e. has higher plasticity relative to a corresponding dough having similar liquid to total dry material ratio, said corresponding dough being absent of said Wolffia plant;
f. higher consistency relative to a corresponding dough having similar liquid to total dry material ratio, said corresponding dough being absent of said Wolffia plant;
g. having essentially homogenous coloring;
h. the color of said mass of dough is optically significantly different from the color of a corresponding dough prepared with the same type and same amount of flour a similar liquid to total dry material ratio, said corresponding dough is further characterized by at least one property selected from the group consisting of: (a) being absent of said Wolffia plant, (b) Wolffia added post kneading, (c) Wolffia added after characteristics of dough have been substantially attained, (d) Wolffia added in addition to the liquid component of said dough, and any combination thereof;
i. a color falling within or being near said plant color range; said plant color is selected from the group consisting of green pigment range, red pigment range and yellow pigment range.

82. The dough of claim 73, wherein said dough comprises at least one of the following:
a. dry plant material, said dough having a ratio (w/w) of said flour to said dry plant material selected from the group consisting of:
i. between about 98:2 to 42:58;
ii. between 97:3 to 55:45;
iii. between 95:5 to 65:35.
b. a liquid component and total dry material, said total dry material comprises flour and plant material when measured in dry form.
c. a weight % ratio of liquid to total dry material selected from the group consisting of:
i. between 55% to 85%;
ii. between 60% to 80%;
iii. between 65% to 75%.
d. plant material having an average diameter selected from the group consisting of:
i. up to 12 mm;
ii. between 0.02 mm and 12 mm;
iii. between 0.03 mm and 2 mm;
iv. between 0.5 mm and 1 mm;
v. 0.6 mm to 1 mm;
vi. less than 1 mm;
e. components of the liquid of the plant, said components are selected from the group consisting of: proteins, protein complexes, saccharides oligosaccharides, fats, vitamins, vitamin A, vitamin B1, vitamin B3 and any combination thereof;
f. plant proteins absorbed by or associated with said flour.

83. The dough of claim 73, wherein at least one of the following holds true:
a. said dough has a characteristic farinographic profile with an intermediate peak before reaching its development time;
b. said dough is characterized by at least one property selected from the group consisting of: a higher development time (DT), a lower stability time (S), a higher degree of softening (DS), a higher consistency (C) value and any combination thereof, as compared to a corresponding dough having similar liquid to total dry material ratio, said corresponding dough being absent of said Wolffia plant.
c. said dough is characterized by at least one farinographic parameter selected from the group consisting of development time (DT) of about 5 minutes, stability time (S) of about 2 minutes, degree of softening (DS) of about 80 to 115 FU and any combination thereof.
d. said dough is characterized by rising at a predetermined time point to a level selected from the group consisting of:
i. that is from about 8% to about 400% greater than the rise at said predetermined time point of a corresponding dough being absent of said plant material;
ii. that is between 10% and 50% greater than the rising of a corresponding dough being absent of said plant material.
e. said dough is being in a cooled or frozen state.

84. The dough of claim 73, wherein said dough has a consistency selected from the group consisting of:
a. similar to a dough in which its liquid fraction comprises water;
b. +/−15% of a dough in which its liquid fraction comprises water;
c. in the range of about 600 to about 630 FU.

85. The dough of claim 73, wherein at least one of the following holds true:
a. said dough additionally comprises salt;
b. said dough is combined with at least one additional food ingredient, said at least one additional food ingredient is selected from the group consisting of flavoring agent, vegetable or vegetable part, oil, vitamins, olives and grains.
c. said dough further comprises a leavening agent, said leavening agent is selected from the group consisting of: unpasteurized beer, buttermilk, ginger beer, kefir, sourdough starter, yeast, whey protein concentrate, yogurt, biological leaveners, chemical leaveners, baking soda, baking powder, baker's ammonia, potassium bicarbonate and any combination thereof;
d. said plant contributes to the rising of said dough as compared to dough prepared without the plant material.
e. said dough has a lower τ_{critic} value relative to a corresponding dough having similar liquid to total dry material ratio, said corresponding dough being absent of said Wolffia plant.

86. The dough of claim 73, wherein at least one of the following holds true:
a. said dough is used to prepare a yeast and non-yeast food product, said food product is in a form selected from the group consisting of partially or fully cooked, baked, stewed, boiled, broiled, fried and any combination of same.
b. said dough is used to make pasta.
c. said dough is used to make wet pasta.

87. A food product comprising the dough of claim 73.

88. The food product of claim 87, wherein at least one of the following holds true:
a. said dough is combined with at least one additional food ingredient.
b. said food product being partially or fully cooked, baked, stewed, boiled, broiled, fried and combination of same.
c. said food product is selected from the group consisting of bakery, pasta, noodles, cereal and dough chips.
d. said food product comprising an overall green or near green pigment texture, and comprising distributed therein Wolffia genus plant.

89. A method of preparing a malleable mass of dough comprising steps of:
a. obtaining dry material; said dry material comprises flour; and,
b. obtaining a liquid component; said liquid component comprising liquid essentially originating from fresh whole Wolffia genus plant;
wherein said method additionally comprising steps of kneading said dry material with said fresh whole Wolffia genus plant to disrupt at least part of said fresh whole plant thereby extracting said liquid component from said fresh whole plant, such that the post kneaded ratio of said whole fresh plant to disrupted plant is at least 50% lower than a corresponding dough comprising same ratio of dry material to liquid component defined as water, said corresponding dough is further characterized by: (i) Wolffia added post kneading, or (ii) Wolffia added after characteristics of dough have been substantially attained, or (iii) Wolffia added in addition to the liquid component of said dough, or any combination thereof.

90. The method of claim 89, additionally comprising at least one step selected from the group consisting of:
a. kneading said dry material with said fresh whole Wolffia genus plant under conditions sufficient to cause disruption of at least part of said fresh whole plant thereby sufficient amount of liquid is extracted from said whole plant to form the dough.
b. selecting said conditions from the group consisting of kneading time, kneader torque moment, kneading velocity, dough temperature, tip speed and any combination thereof.
c. kneading at least flour and fresh plant for a time interval between the dough reaches its arrival time and the dough's departure time as determined by a farinograph profile of said dough.
d. kneading said flour and fresh plant with at least one additional food ingredient.
e. selecting said at least one additional food ingredient from the group consisting of leavening agent, flavoring agent, vegetable or vegetable part, oil, vitamins, salt, grains and any combination thereof.
f. cooling or freezing said dough.

91. The method of claim 89, wherein at least one of the following holds true:
a. at least 80% of said liquid component comprises liquid originating from said fresh whole Wolffia.
b. about 100% of said liquid component comprises liquid originating from said fresh whole Wolffia.

92. A method of preparing food product comprising steps of providing a dough as claimed in claim 73 and processing said dough, said processing is selected from the group consisting of combining the dough with a food ingredient, rising, kneading, extruding, molding, shaping, cooking, stewing, boiling, broiling, baking, frying and any combination of same.
